(19) United States
(12) Patent Application Publication
(10) Pub. No.: US 2026/0039644 A1
(43) Pub. Date: Feb. 5, 2026

(54) API INVOKER AUTHENTICATION METHOD AND APPARATUS, COMMUNICATION DEVICE, AND STORAGE MEDIUM

(71) Applicant: Beijing Xiaomi Mobile Software Co., Ltd., Beijing (CN)

(72) Inventors: Haoran LIANG, Beijing (CN); Wei LU, Beijing (CN)

(73) Assignee: Beijing Xiaomi Mobile Software Co., Ltd., Beijing (CN)

(21) Appl. No.: 18/996,621

(22) PCT Filed: Jul. 29, 2022
(86) PCT No.: PCT/CN2022/109268

§ 371 Date: Jan. 17, 2025

(51) Int. Cl. H04L 9/40

(52) U.S. Cl. CPC H04L 63/0823; H04L 63/166

(57) ABSTRACT

A method for authenticating an application program interface (API) invoker enhances secure communication between API invokers and a Common Application Program Interface Framework (CAPIF). The method involves sending authentication information from the API invoker to the CAPIF function, which authenticates the invoker's identity. The process includes obtaining enrollment information to establish a secure transport layer security (TLS) connection with the CAPIF function. Advanced authentication mechanisms leverage an authentication and key management for applications (AKMA) anchor key, enabling secure derivation and verification of application function keys (KAF). Additionally, the CAPIF function uses received authentication data to retrieve API invoker configuration information, onboard signing keys, and certificates. These elements facilitate secure API access and interaction while ensuring compliance with authentication protocols.

### CROSS-REFERENCE TO RELATED APPLICATION

The present application is a U.S. National Stage of International Application No. PCT/CN2022/109268, filed on Jul. 29, 2022, the contents of which are incorporated herein by reference in their entirety.

### TECHNICAL FIELD

The present disclosure relates to, but is not limited to, the field of communication technologies, in particular to an API invoker authentication method and apparatus, a communication device, and a storage medium.

### BACKGROUND

In related technologies, one of the objectives of the study on subscriber-aware northbound API access (SNA) Application (APP) security is to address the security aspects of user equipment (UE) originated application program interface (API) invocation. In SNA scenarios, UE can serve as an API invoker, and API invoker onboarding is an important procedure. During the API invoker onboarding procedure, the Common API Framework (CAPIF) function needs to authenticate API invoker before authorizing services to API invoker. However, in CAPIF, there is no existing solution to enable CAPIF function to authenticate API invoker.

### SUMMARY

An embodiment of the present disclosure provides an API invoker authentication method and apparatus, a communication device, and a storage medium.

According to a first aspect of an embodiment of the present disclosure, an API invoker authentication method is provided, which is performed by an API invoker, including:
sending first request information to a common application program interface framework (CAPIF) function, where the first request information includes authentication information of the API invoker, and the authentication information is used for the CAPIF function to authenticate an identity of the API invoker.

In some embodiments, the method includes: obtaining enrolment information from an API provider domain or preconfigured information of the API invoker, where the enrolment information includes at least one of:
an address of the CAPIF function;
a fully qualified domain name (FQDN) of the CAPIF function; or
a root certificate authority (CA) certificate of CAPIF function.

In some embodiments, the method includes: establishing, based on the enrolment information, a transport layer security (TLS) connection with the CAPIF function;
where the sending the first request information to a CAPIF function includes: sending, based on the TLS connection, the first request information to the CAPIF function.

In some embodiments, the authentication information includes: an authentication and key management for applications (AKMA) key identifier corresponding to an AKMA anchor key, where the AKMA key identifier is used for determining the AKMA anchor key, and the AKMA anchor key is used for the CAPIF function to authenticate the identity of the API invoker.

In some embodiments, the method includes: determining, based on an authentication server function key (K_{AUSF}), the AKMA anchor key and the AKMA key identifier corresponding to the AKMA anchor key; and
determining, based on the AKMA anchor key, a first application function key (K_{AF}).

In some embodiments, determining, based on the AKMA anchor key, a first K_{AF} includes one of the following:
determining the first K_{AF} based on the AKMA anchor key and identification information of the CAPIF function, where the identification information of the CAPIF function includes: a fully qualified domain name (FQDN) and/or a security protocol identifier, and the security protocol identifier is determined by negotiation between the API invoker and the CAPIF function.

In some embodiments, the method includes: determining, based on the first K_{AF} and a second K_{AF} of the CAPIF function, whether the identity authentication of the API invoker is successful.

In some embodiments, the authentication information includes: a first certificate, where the first certificate is used for the CAPIF function to authenticate the identity of the API invoker.

In some embodiments, the method includes: receiving first response information sent by the CAPIF function, where the first response information includes:
API invoker configuration information, where the API invoker configuration information includes: API exposing function (AEF) authentication and authorization information;
an API invoker's certificate, where the API invoker's certificate includes: identification information of the API invoker and a public key of the API invoker; and
an onboard signing key of the API invoker.

In some embodiments, the identification information of the API invoker includes one of:
identification information of the API invoker assigned by CAPIF function;
a subscription permanent identifier (SUPI);
a generic public subscription identifier (GPSI);
an internet protocol multimedia subsystem (IMS) private identity (IMPI);
a subscription concealed identifier (SUCI); and
an application layer identification (ID) of UE.

In some embodiments, the first request information further includes: a token of the API invoker, where the first response information is sent by the CAPIF function after successful verification based on the token.

In some embodiments, the API invoker includes: a UE.

In some embodiments, the CAPIF function includes one of:
a CAPIF core function (CCF);
an API exposing function (AEF); and
an authorization function (AF).

According to a second aspect of an embodiment of the present disclosure, an API invoker authentication method is provided, which is performed by an authentication and key management for applications (AKMA) Anchor Function (AAnF), including:
receiving second request information sent by a common application program interface framework (CAPIF) function, where the second request information is determined by the CAPIF function based on first request information, and the second request information includes an AKMA key identifier of an API invoker included in the first request information; and
determining, based on the AKMA key identifier, an AKMA anchor key corresponding to the AKMA key identifier, where the AKMA anchor key is used for the CAPIF function to authenticate an identity of the API invoker.

In some embodiments, the method includes:
determining a second application function key (K_{AF}) based on the AKMA anchor key; and
sending second response information to the CAPIF function, where the second response information includes the second K_{AF}.

In some embodiments, the second response information further includes: a valid time corresponding to the second K_{AF} and/or identification information of the API invoker.

In some embodiments, the identification information of the API invoker includes one of the following: a SUPI, a GPSI, an IMPI, a SUCI and an application layer ID of UE.

In some embodiments, the second request information includes: identification information of the CAPIF function;
where the determining a second K_{AF} based on the AKMA anchor key includes:
determining the second K_{AF} based on the AKMA anchor key and the identification information of the CAPIF function.

In some embodiments, the identification information of the CAPIF function includes: a fully qualified domain name (FQDN) and/or a security protocol identifier, and the security protocol identifier is determined by negotiation between the API invoker and the CAPIF function.
where the determining the second K_{AF} based on the AKMA anchor key and the identification information of the CAPIF function includes one of:
determining the second K_{AF} based on the AKMA anchor key and the FQDN; and
determining the second K_{AF} based on the AKMA anchor key, the FQDN and the security protocol identifier.

In some embodiments, the method includes: determining, based on the identification information of the CAPIF function, whether the AAnF is capable of providing a service to the CAPIF function;
where the determining, based on the AKMA key identifier, an AKMA anchor key corresponding to the AKMA key identifier includes:
in response to determining that the AAnF is capable of providing the service to the CAPIF function, determining, based on the AKMA key identifier, the AKMA anchor key corresponding to the AKMA key identifier.

In some embodiments, the method includes: in response to determining that the AAnF is not capable of providing the service to the CAPIF function, refusing to provide the second K_{AF} to the CAPIF.

In some embodiments, the method includes: sending, based on the AKMA anchor key corresponding to the AKMA key identifier is not present in the AAnF, the second response information with error indication information to the CAPIF function.

In some embodiments, the API invoker includes: a UE.

In some embodiments, the CAPIF function includes one of the following:
a CAPIF core function (CCF);
an API exposing function (AEF); and
an authorization function (AF).

According to a third aspect of an embodiment of the present disclosure, an API invoker authentication method is provided, which is performed by a CAPIF function, including:
receiving first request information sent by an application program interface (API) invoker, where the first request information includes authentication information of the API invoker, and the authentication information is used for authenticating an identity of the API invoker.

In some embodiments, the authentication information includes an AKMA key identifier corresponding to an AKMA anchor key, where the AKMA key identifier is used for determining the AKMA anchor key, and the AKMA anchor key is used for authenticating the identity of the API invoker.

In some embodiments, the method includes: sending second request information to an AKMA anchor function (AAnF), where the second request information includes the AKMA key identifier, and the AKMA key identifier is used for the AAnF to determine the AKMA anchor key, and the AKMA anchor key is used for the AAnF to determine a second application function key (K_{AF}) of the CAPIF function.

In some embodiments, the method includes: authenticating, based on the second K_{AF} and a first K_{AF} of the API invoker, the identity of the API invoker.

In some embodiment, the method includes: determining, based on the AKMA key identifier, the AAnF corresponding to the CAPIF function.

In some embodiments, the method includes: receiving second response information sent by the AAnF, where the second response information includes at least one of:
the second K_{AF};
identification information of the API invoker and the second K_{AF};
the second K_{AF} and a valid time corresponding to the second K_{AF}; or
identification information of the API invoker, the second K_{AF} and a valid time corresponding to the second K_{AF}.

In some embodiments, the identification information of the API invoker includes one of the following: a SUPI, a GPSI, an IMPI, a SUCI and an application layer ID of UE.

In some embodiments, the second request information includes: identification information of the CAPIF function, where the identification information of the CAPIF function includes: a fully qualified domain name (FQDN) and/or a security protocol identifier, and the security protocol identifier is determined by negotiation between the API invoker and the CAPIF function; and the AKMA anchor key and the identification information of the CAPIF function are used for the AAnF to determine the second K_{AF}.

In some embodiments, the authentication information includes: a first certificate, where the first certificate is used for the CAPIF function to authenticate the identity of the API invoker.

In some embodiment, the method includes: determining, based on the first certificate and a root certificate corresponding to the first certificate stored by the CAPIF function, whether the identity authentication of the API invoker is successful.

In some embodiments, the method includes at least one of:
determining, based on successful identity authentication of the API invoker, an onboard signing key of the API invoker;
determining, based on successful identity authentication of the API invoker, API invoker configuration information of the API invoker, where the API invoker configuration information includes: API exposing function (AEF) authentication and authorization information; or
generating, based on successful identity authentication of the API invoker, an API invoker's certificate, where the API invoker's certificate includes a public key of the API invoker and identification information of the API invoker.

In some embodiments, the first request information further includes: a token of the API invoker;
where the determining API invoker configuration information of the API invoker includes: determining, based on the successful identity authentication of the API invoker, the API invoker configuration information according to the token.

In some embodiments, the method includes: sending first response information to the API invoker, where the first response information includes at least one of: onboard signing information of the API invoker, the API invoker configuration information and the API invoker's certificate.

In some embodiments, the API invoker includes: a UE.

In some embodiments, the CAPIF function includes one of: a CCF, an AEF, and an AF.

According to a fourth aspect of an embodiment of the present disclosure, an API invoker authentication apparatus is provided, including:
a sending module, configured to send first request information to a CAPIF function, where the first request information includes authentication information of the API invoker, and the authentication information is used for the CAPIF function to authenticate an identity of the API invoker.

In some embodiments, the apparatus includes: a receiving module, configured to obtain enrolment information from an API provider domain or preconfigured information of the API invoker, where the enrolment information includes at least one of:
an address of the CAPIF function;
a FQDN of the CAPIF function; or
a root CA certificate of CAPIF function.

In some embodiments, the apparatus includes: a processing module, configured to establish, based on the enrolment information, a TLS connection with the CAPIF function; and
the sending module is configured to send, based on the TLS connection, the first request information to the CAPIF function.

In some embodiments, the authentication information includes an AKMA key identifier corresponding to an AKMA anchor key, where the AKMA key identifier is used for determining the AKMA anchor key, and the AKMA anchor key is used for the CAPIF function to authenticate the identity of the API invoker.

In some embodiments, the apparatus includes: the processing module, configured to determine, based on an authentication server function key (K_{AUSF}), the AKMA anchor key and the AKMA key identifier corresponding to the AKMA anchor key; and
the processing module is further configured to determine, based on the AKMA anchor key, a first K_{AF}.

In some embodiments, the processing module is configured to determine the first K_{AF} based on the AKMA anchor key and identification information of the CAPIF function, where the identification information of the CAPIF function includes: a fully qualified domain name (FQDN) and/or a security protocol identifier, and the security protocol identifier is determined by negotiation between the API invoker and the CAPIF function.

In some embodiments, the apparatus includes: the processing module, configured to determine, based on the first K_{AF} and a second K_{AF} of the CAPIF function, whether the identity authentication of the API invoker is successful.

In some embodiments, the authentication information includes: a first certificate, where the first certificate is used for the CAPIF function to authenticate the identity of the API invoker.

In some embodiments, the apparatus includes: the receiving module, configured to receive first response information sent by the CAPIF function, where the first response information includes:
API invoker configuration information, where the API invoker configuration information includes: API exposing function (AEF) authentication and authorization information;
an API invoker's certificate, where the API invoker's certificate includes: identification information of the API invoker and a public key of the API invoker; and
an onboard signing key of the API invoker.

In some embodiments, the identification information of the API invoker includes one of: identification information of the API invoker assigned by the CAPIF function, a SUPI, a GPSI, an IMPI, a SUCI and an application layer ID of UE.

In some embodiments, the first request information further includes: a token of the API invoker, where the first response information is sent by the CAPIF after successful verification based on the token.

In some embodiments, the API invoker includes: a UE.

In some embodiments, the CAPIF function includes one of: a CCF, an AEF, and an AF.

According to a fifth aspect of an embodiment of the present disclosure, an API invoker authentication apparatus is provided, which is performed by an AAnF and including:
a receiving module, configured to receive second request information sent by a common application program interface framework (CAPIF) function, where the second request information is determined by the CAPIF function based on first request information, and the second request information includes an AKMA key identifier of an API invoker included in the first request information; and
a processing module, configured to determine, based on the AKMA key identifier, an AKMA anchor key corresponding to the AKMA key identifier, where the AKMA anchor key is used for the CAPIF function to authenticate an identity of the API invoker.

In some embodiments, the apparatus includes: the processing module, configured to determine a second K_{AF} based on the AKMA anchor key; and
a sending module, configured to send second response information to the CAPIF, where the second response information includes the second K_{AF}.

In some embodiments, the second response information further includes; a valid time corresponding to the second K_{AF} and/or identification information of the API invoker.

In some embodiments, the identification information of the API invoker includes one of the following: a SUPI, a GPSI, an IMPI, a SUCI and an application layer ID of UE.

In some embodiments, the second request information includes: identification information of the CAPIF function;
the processing module is configured to determine the second K_{AF} based on the AKMA anchor key and the identification information of the CAPIF function.

In some embodiments, the identification information of the CAPIF function includes: a fully qualified domain name (FQDN) and/or a security protocol identifier, and the security protocol identifier is determined by negotiation between the API invoker and the CAPIF function;
the processing module is configured to determine the second K_{AF} based on the AKMA anchor key and the FQDN;
or, the processing module is configured to determine the second K_{AF} based on the AKMA anchor key, the FQDN and the security protocol identifier.

In some embodiments, the apparatus includes: the processing module, configured to determine, based on the identification information of the CAPIF function, whether the AAnF is capable of providing a service to the CAPIF function; and
the processing module, in response to determining that the AAnF is capable of providing the service to the CAPIF function, is further configured to: determine, based on the AKMA key identifier, the AKMA anchor key corresponding to the AKMA key identifier.

In some embodiments, the apparatus includes: the processing module, configured to refuse to provide the second K_{AF} to the CAPIF in response to determining that the AAnF is not capable of providing the service to the CAPIF function.

In some embodiments, the apparatus includes: the sending module, configured to send, based on the AKMA anchor key corresponding to the AKMA key identifier is not present in the AAnF, the second response information with error indication information to the CAPIF function.

In some embodiments, the API invoker includes: a UE.

In some embodiments, the CAPIF function includes one of: a CCF, an AEF and an AF.

According to a sixth aspect of an embodiment of the present disclosure, an API invoker authentication apparatus is provided, which is performed by a CAPIF function, including:
a receiving module, configured to receive first request information sent by an application program interface (API) invoker, where the first request information includes authentication information of the API invoker, and the authentication information is used for authenticating an identity of the API invoker.

In some embodiments, the authentication information includes an AKMA key identifier corresponding to an AKMA anchor key, where the AKMA key identifier is used for determining the AKMA anchor key, and the AKMA anchor key is used for authenticating the identity of the API invoker.

In some embodiments, the apparatus includes: a sending module, configured to send second request information to an AKMA anchor function (AAnF), where the second request information includes the AKMA key identifier, and the AKMA key identifier is used for the AAnF to determine the AKMA anchor key, and the AKMA anchor key is used for the AAnF to determine a second application function key (K_{AF}) of the CAPIF function.

In some embodiments, the apparatus includes: a processing module, configured to authenticate, based on the second K_{AF} and a first K_{AF} of the API invoker, the identity of the API invoker.

In some embodiment, the apparatus includes: the processing module, configure to determine, based on the AKMA key identifier, the AAnF corresponding to the CAPIF function.

In some embodiments, the apparatus includes: the receiving module, configured to receive second response information sent by the AAnF, where the second response information includes at least one of:
the second K_{AF};
identification information of the API invoker and the second K_{AF};
the second KAF and a valid time corresponding to the second K_{AF}; or
identification information of the API invoker, the second K_{AF} and a valid time corresponding to the second K_{AF}.

In some embodiments, the identification information of the API invoker includes one of the following: a SUPI, a GPSI, an IMPI, a SUCI and an application layer ID of UE.

In some embodiments, the second request information includes: identification information of the CAPIF function, where the identification information of the CAPIF function includes a fully qualified domain name (FQDN) and/or a security protocol identifier, and the security protocol identifier is determined by negotiation between the API invoker and the CAPIF function; and the AKMA anchor key and the identification information of the CAPIF function are used for the AAnF to determine the second KAF.

In some embodiments, the authentication information includes: a first certificate, where the first certificate is used for the CAPIF function to authenticate the identity of the API invoker.

In some embodiments, the apparatus includes: a processing module, configured to determine, based on the first certificate and a root certificate corresponding to the first certificate stored by the CAPIF function, whether the identity authentication of the API invoker is successful.

In some embodiments, the processing module is configured to at least one of:
determine, based on successful identity authentication of the API invoker, an onboard signing key of the API invoker;
determine, based on successful identity authentication of the API invoker, API invoker configuration information of the API invoker, where the API invoker configuration information includes: API exposing function (AEF) authentication and authorization information; or
generate, based on successful identity authentication of the API invoker, an API invoker's certificate, where the API invoker's certificate includes a public key of the API invoker and identification information of the API invoker.

In some embodiments, the first request information further includes: a token of the API invoker;
the processing module configured to determine API invoker configuration information of the API invoker including: determining, based on the successful identity authentication of the API invoker, the API invoker configuration information according to the token.

In some embodiments, the apparatus includes: the sending module, configured to send first response information to the API invoker, where the first response information includes at least one of: onboard signing information of the API invoker, the API invoker configuration information and the API invoker's certificate.

In some embodiments, the API invoker includes: a UE.

In some embodiments, the CAPIF function includes one of: a CCF, an AEF, and an AF.

According to a seventh aspect of the present disclosure, a communication device is provided, including:
a processor; and
a memory, configured to store instructions executable by the processor;
where the processor is configured to implement the API invoker authentication method of any embodiment of the present disclosure when executing executable instructions.

According to an eighth aspect of an embodiment of the present disclosure, a computer storage medium is provided, where the computer storage medium stores a computer executable program, and the executable program, when executed by a processor, realizes the API invoker authentication method described in any embodiment of the present disclosure.

The technical solutions provided by the embodiments of the present disclosure can include the following beneficial effects.

In an embodiment of the present disclosure, the API invoker sends the first request information to the CAPIF function, where the first request information includes the authentication information of the API invoker, and the authentication information is used for the CAPIF function to authenticate the identity of the API invoker. In this way, the CAPIF can effectively authenticate the identity of the API invoker based on the authentication information.

It should be understood that the above general description and the following detailed descriptions are exemplary and explanatory only and do not limit the embodiments of the present disclosure.

### BRIEF DESCRIPTION OF DRAWINGS

FIG. 1 is a schematic structural diagram of a wireless communication system according to an embodiment of the present disclosure.

FIG. 2 is a schematic diagram of an API invoker authentication method according to an embodiment of the present disclosure.

FIG. 3 is a schematic diagram of an API invoker authentication method according to an embodiment of the present disclosure.

FIG. 4 is a schematic diagram of an API invoker authentication method according to an embodiment of the present disclosure.

FIG. 5 is a schematic diagram of an API invoker authentication method according to an embodiment of the present disclosure.

FIG. 6 is a schematic diagram of an API invoker authentication method according to an embodiment of the present disclosure.

FIG. 7 is a schematic diagram of an API invoker authentication method according to an embodiment of the present disclosure.

FIG. 8 is a schematic diagram of an API invoker authentication method according to an embodiment of the present disclosure.

FIG. 9 is a schematic diagram of an API invoker authentication method according to an embodiment of the present disclosure.

FIG. 10 is a schematic diagram of an API invoker authentication method according to an embodiment of the present disclosure.

FIG. 11 is a schematic diagram of an API invoker authentication method according to an embodiment of the present disclosure.

FIG. 12 is a schematic diagram of an API invoker authentication method according to an embodiment of the present disclosure.

FIG. 13 is a schematic diagram of an API invoker authentication method according to an embodiment of the present disclosure.

FIG. 14 is a block diagram of an API invoker authentication apparatus according to an embodiment of the present disclosure.

FIG. 15 is a block diagram of an API invoker authentication apparatus according to an embodiment of the present disclosure.

FIG. 16 is a block diagram of an API invoker authentication apparatus according to an embodiment of the present disclosure.

FIG. 17 is a block diagram of a UE according to an embodiment of the present disclosure.

FIG. 18 is a block diagram of a base station according to an embodiment of the present disclosure.

### DETAILED DESCRIPTION

Reference will now be made in detail to embodiments of the present disclosure, examples of which are illustrated in the accompanying drawings. When the following description refers to the accompanying drawings, unless otherwise indicated, the same numbers in different accompanying drawings indicate the same or similar elements. Implementations described in the following embodiment of the present disclosure do not represent all implementations consistent with the embodiments of the present disclosure. Rather, they are merely examples of apparatuses and methods consistent with some aspects of embodiments of the present disclosure as detailed in the appended claims.

Terms used in embodiments of the present disclosure are only for a purpose of describing specific embodiments, and are not limiting the embodiments of the present disclosure. Singular forms of “a,” said,” and “the” used in the embodiments of the present disclosure and in the claims are also intended to include majority forms, unless the context clearly indicates otherwise. It should also be understood that the term “and/or” as used herein refers to any or all of the possible combinations containing one or more of the listed items in association.

It should be understood that although terms first, second, third, etc. may be used to describe various information in the embodiments of the present disclosure, these information should not be limited to these terms. These terms are used only to distinguish the same type of information from one another. For example, without departing from the scope of the present disclosure, first information can also be named as second information, and similarly, the second information can also be named as the first information. Depending on the context, the word “if” as used herein can be interpreted as “at” or “when” or “in response to determining”.

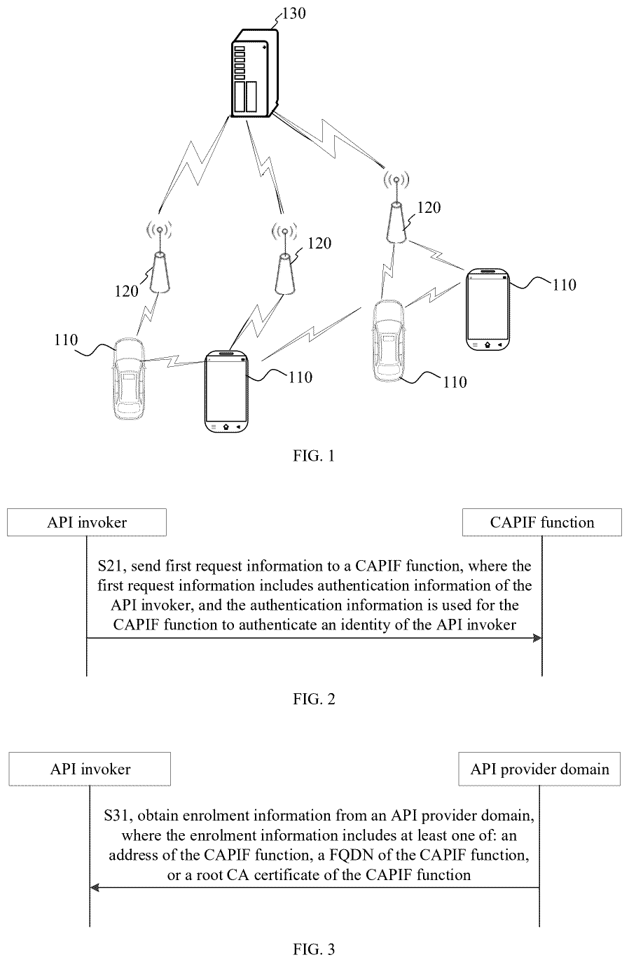

Please refer to FIG. 1, which shows a schematic structural diagram of a wireless communication system according to an embodiment of the present disclosure. As shown in FIG. 1, the wireless communication system is a communication system based on cellular mobile communication technology, which may include several user equipments 110 and several base stations 120.

A user equipment 110 may be a device that provides voice and/or data connectivity to users. The user equipment 110 can communicate with one or more core networks via a radio access network (RAN). The user equipment 110 can be an Internet of Things user equipment, such as a sensor device, a mobile phone (or a “cellular” phone) and a computer with an Internet of Things user equipment. For example, it can be a fixed, portable, pocket-sized, handheld, computer-built or vehicle-mounted device. For example, a station (STA), a subscriber unit, a subscriber station, a mobile station, a mobile, a remote station, an access point, a remote terminal, an access terminal, a user terminal, a user agent, a user device, or a user equipment. Or, the user equipment 110 can also be a device for an unmanned aerial vehicle. Or, the user equipment 110 can also be a vehicle-mounted device, for example, a driving computer with wireless communication function or a wireless user equipment with an external driving computer. Or, the user equipment 110 can also be a roadside device, such as a street lamp, a signal lamp or other roadside device with wireless communication function.

The base station 120 may be a network-side device in a wireless communication system. The wireless communication system can be the 4th generation mobile communication (4G) system, also known as long term evolution (LTE) system. Or, the wireless communication system can also be a 5G system, also known as a new radio (NR) system or a 5G NR system. Or, the wireless communication system can also be a further next-generation system of a 5G system. An access network in the 5G system can be named as a new generation-radio access network (NG-RAN).

The base station 120 may be an evolved Node B (eNB) adopted in the 4G system. Or, the base station 120 can also be a next generation Node B (gNB) adopting a centralized and distributed architecture in the 5G system. When the base station 120 adopts a centralized and distributed architecture, it usually includes a central unit (CU) and at least two distributed units (DUs). The centralized unit is provided with a protocol stack of a packet data convergence protocol (PDCP) layer, a radio link Control Protocol (RLC) layer and a media access control (MAC) layer, a distributed unit is provided with a protocol stack of a physical (PHY) layer, and the embodiments of the present disclosure do not limit specific implementations of the base station 120.

A wireless connection can be established between the base station 120 and the user equipment 110 through a wireless air interface. In different implementations, the wireless air interface is a wireless air interface based on the fourth generation mobile communication network technology (4G) standard; or the wireless air interface is a wireless air interface based on the fifth generation mobile communication network technology (5G) standard, for example, the wireless air interface is a new radio; or, the wireless air interface can also be a wireless air interface based on a more next generation mobile communication network technology standard based on 5G.

In some embodiments, an end to end (E2E) connection can further be established between the user equipments 110. For example, scenarios of vehicle to vehicle (V2V) communication, vehicle to infrastructure (V2I) communication and vehicle to pedestrian (V2P) communication in vehicle to everything (V2X) communication.

Here, the above-mentioned user equipment can be considered as a terminal device of the following embodiments.

In some embodiments, the wireless communication system may further include a network management device 130.

Several base stations 120 are respectively connected to a network management device 130. The network management device 130 may be a core network device in a wireless communication system. For example, the network management device 130 may be a mobility management entity (MME) in an evolved packet core (EPC). Or, the network management device can also be other core network devices, such as a serving gateway (SGW), a public data network gateway (PGW), a policy and charging rules function (PCRF) or a home subscriber server (HSS), etc. Embodiments of the present disclosure do not limit the implementation form of the network management device 130.

In order to facilitate the understanding of those skilled in the art, the embodiments of the present disclosure list a plurality of implementations to clearly explain the technical solution of the embodiments of the present disclosure. Of course, those skilled in the art can understand that the multiple embodiments provided in the present disclosure can be executed separately, combined with the methods of other embodiments in the present disclosure, or executed separately or in combination with some methods in other related technologies. Embodiment of that present disclosure do not limit this.

In order to better understand the technical solutions described in any of the embodiments of the present disclosure, first, some related technologies are explained.

In some application scenarios, one of the objectives of the study on subscriber-aware northbound API access (SNA) Application (APP) security is to address the security aspects of user equipment (UE) originated application program interface (API) invocation. In SNA scenarios, UE can be served as an API invoker. Specifically, in TS 22.261 clause 6.10.2, it states that “provide a UE with secure access to APIs (e.g. triggered by an application that is not visible to the 5G system), by authenticating and authorizing the UE”. It is understood that the applications (APPs) running on the UE are not visible to 3GPP system and the UE needs to be authenticated and authorized. Also, SA6 SID [2] states that “Note that the UE triggering the API invocation (hereinafter referred to as the triggering UE) may be different from the UE whose service experience gets affected by the API invocation (hereinafter referred to as the resource owner),” so authentication and authorization of the invoker UE is also important to secure service experience of the target UE.

During the API invoker onboarding procedure, CAPIF function needs to authenticate API invoker before authorizing services to API invoker. However, in CAPIF, there is no existing solution to enable CAPIF function to authenticate API invoker.

As shown in FIG. 2, an embodiment of the present disclosure provides an API invoker authentication method, which is performed by an API invoker, including the following step.

At step S21, sending first request information to a CAPIF function, where the first request information includes authentication information of the API invoker, and the authentication information is used for the CAPIF function to authenticate an identity of the API invoker.

In an embodiment, the API invoker may be, but is not limited to, a UE. Here, it may be various mobile terminals or fixed terminals. For example, the UE may be, but is not limited to, a mobile phone, a computer, a server, a wearable device, a vehicle-mounted terminal, a game control platform or a multimedia device.

In an embodiment, the CAPIF function may be, but is not limited to: a CAPIF core function (CCF), an API exposing function (AEF) and an authorization function (AF). Here, CCF, AEF and AF can all be flexibly deployed logical nodes or functions in CAPIF. Here, the AF may also be a logical node or function in the core network or in a network accessing the core.

Here, the CAPIF function can be other logical nodes or functions flexibly deployed in CAPIF. The CAPIF function can be a network function deployed by an operator.

For example, the API invoker sends the first request information to CCF, or the API invoker sends the first request information to AEF, or the API invoker sends the first request information to AF.

For example, the UE sends the first request information to CCF, or the API invoker sends the first request information to AEF, or the API invoker sends the first request information to AF.

The AAnF referred to in the following embodiments of the present disclosure may be, for example, a logical node or function flexibly deployed in a communication network. For example, the AAnF may be a logical node or function on a core network side; for another example, the AAnF may be a logical node or function in a data network connected to the core network.

In an embodiment, the first request information may be an Onboard API invoker request message.

In an embodiment, the authentication information may be, but is not limited to, an AKMA key identifier corresponding to the AKMA anchor key and/or certificate information. Here, either the AKMA anchor key or the certificate information is available for the CAPIF function to authenticate the identity of the API invoker.

In an embodiment, the first request information may include, but is not limited to, at least one of: a token of the API invoker, a key pair of the API invoker, and a public key of the API invoker. Here, the key pair of the API invoker includes a private key of the API invoker and a public key of the API invoker. Here, the token of the API invoker may be, but is not limited to, an OAuth 2.0 token. Of course, the token of the API invoker can also be another access token (OAuth), etc. Here, the public key of the API invoker may be any kind of public key, e.g., it may be a pre-set string, etc. Here, the token of the API invoker and/or the public key of the API invoker may facilitate the CAPIF to further authenticate the identity of the API invoker.

In an embodiment of the present disclosure, the API invoker sends the first request information to the CAPIF function, where the first request information includes the authentication information of the API invoker, and the authentication information is used for the CAPIF function to authenticate the identity of the API invoker. In this way, the CAPIF can effectively authenticate the identity of the API invoker based on the authentication information.

In this way, the embodiment of the present disclosure can improve the security protection of the service of the target UE when the API invoker invokes the service of the target UE.

In an embodiment, sending the first request information to the CAPIF function in step S21 may include: sending the first request information before or during SNA. In this way, the embodiment of the present disclosure can authenticate the identity of the API invoker when the API invoker applies SNA, so as to enhance the service security protection of the invoked UE.

It should be noted that those skilled in the art can understand that the methods provided by the embodiments of the present disclosure can be executed alone or together with some methods in the embodiments of the present disclosure or some methods in related technologies.

As shown in FIG. 3, an embodiment of the present disclosure provides an API invoker authentication method, which is performed by an API invoker, including the following step.

At step S31, obtaining enrolment information from an API provider domain, where the enrolment information includes at least one of: an address of the CAPIF function; a fully qualified domain name (FQDN) of the CAPIF function; or a root certificate authority (CA) certificate of the CAPIF function.

An embodiment of the present disclosure provides an API invoker authentication method, which is performed by an API invoker, including: obtaining enrolment information from preconfigured information of the API invoker, where the enrolment information includes at least one of: an address of the CAPIF function; a fully qualified domain name (FQDN) of the CAPIF function; or a root certificate authority (CA) certificate of the CAPIF function.

In some embodiments of the present disclosure, the CAPIF function may be the CAPIF function in step S21.

In an embodiment, the API provider domain may be a function or a logical node; for example, the API provider domain is a function integrated in the CAPIF that manages information about API invokers and/or CAPIF functions. For example, the API provider domain can manage tokens of API invokers and so on.

In an embodiment, at least one piece of preconfigured information of API invoker is stored in the API invoker. Or, the API invoker may obtain the preconfigured information of the API invoker from other network elements.

In an embodiment, the address of the CAPIF function may be, but is not limited to, a physical address of CAPIF, etc.

In an embodiment, the FQDN of the CAPIF function may be, but is not limited to, a combination of a host name and a domain name of the CAPIF function, or a name of a host name with the CAPIF function and a domain name. For example, the host name of the CAPIF function is “bigserver” and the domain name of the CAPIF function is “mycompany.com,” and the FQDN could be “bigserver. mycompany.com”.

In an embodiment, the root CA certificate of the CAPIF function can be any kind of root CA certificate.

In an embodiment, the enrolment information may be onboarding enrolment information.

In this way, in the embodiment of the present disclosure, the API invoker may obtain the enrolment information from the API provider domain or the preconfigured information of the API invoker, and the enrolment information may include at least one of the address, FQDN or root certificate of the CAPIF function, which is beneficial for the API invoker to perform subsequent operations based on the enrolment information, for example, it may establish a connection with the CAPIF.

In some embodiments, the method includes: establishing a TLS connection with the CAPIF function based on the enrolment information.

Sending the first request information to the CAPIF function in step S21 includes: sending the first request information to the CAPIF function based on the TLS connection.

An embodiment of the present disclosure provides an API invoker authentication method, which is performed by an API invoker, including:
establishing a TLS connection with the CAPIF function based on the enrolment information; and
sending the first request information to the CAPIF function based on the TLS connection.

Here, the TLS connection is mutually authenticated with the API invoker through a CAPIF function of a CAPIF interface.

Here, the API invoker may establish a TLS session with the CAPIF via a TLS connection, and the API invoker may send the first request information to the CAPIF via the TLS session.

For example, the API invoker may establish a TLS connection with the CAPIF function based on the address and/or FQDN of the CAPIF function.

In this way, in the embodiment of the present disclosure, the API invoker may establish a TLS connection with the CAPIF based on the enrolment information, so that the API invoker may send the first request information to the CAPIF via the TLS connection. Thus, the sending of the first request information is realized.

It should be noted that those skilled in the art can understand that the methods provided by the embodiments of the present disclosure can be executed alone or together with some methods in the embodiments of the present disclosure or some methods in related technologies.

In some embodiments, the authentication information includes an AKMA key identifier corresponding to an AKMA anchor key, where the AKMA key identifier is used for determining the AKMA anchor key, and the AKMA anchor key is used for the CAPIF function to authenticate the identity of the API invoker.

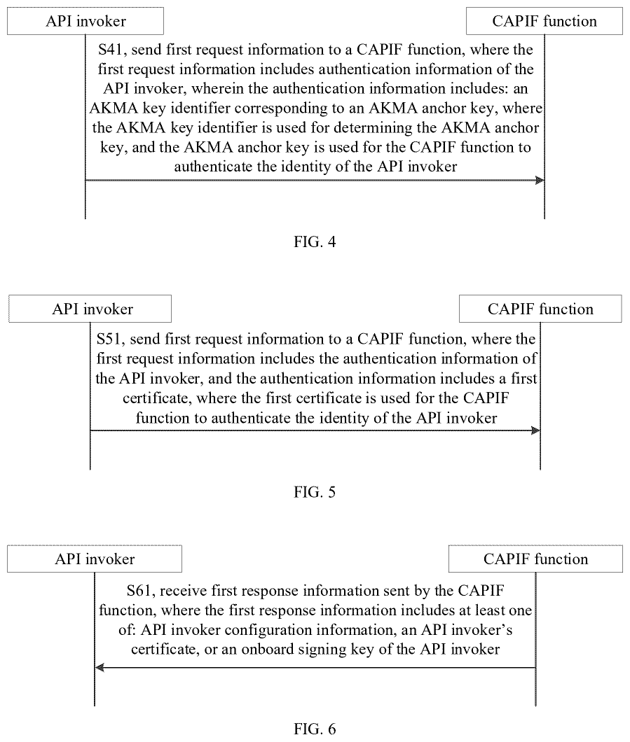

As shown in FIG. 4, an embodiment of the present disclosure provides an API invoker authentication method, which is performed by an API invoker, including the following step.

At step S41, sending first request information to a CAPIF function, where the first request information includes authentication information of the API invoker; where the authentication information includes: an AKMA key identifier corresponding to an AKMA anchor key, where the AKMA key identifier is used for determining the AKMA anchor key, and the AKMA anchor key is used for the CAPIF function to authenticate the identity of the API invoker.

In some embodiments of the present disclosure, the first request information and authentication information may be the first request information and authentication information in step S21, respectively.

Here, the AKMA anchor key is used to determine a K_{AF}, which is used for the CAPIF function to authenticate the identity of the API invoker. The K_{AF} may be a first K_{AF} or a second K_{AF} referred to below.

In an embodiment, the AKMA key identifier may be: A-KID.

Here, the AKMA key identifier carried in the first request information is used for AAnF to determine the AKMA anchor key, and the AKMA anchor key is used for the AAnF to generate a K_{AF}. For example, the AAnF determines the AKMA anchor key corresponding to the AKMA key identifier based on the AKMA key identifier, and determine a second K_{AF} based on the AKMA anchor key. The AAnF sends the second K_{AF} to the CAPIF function, so that the CAPIF function can authenticate the identity of the API invoker.

In an embodiment of the present disclosure, the API invoker may send the first request information to the CAPIF function, where the first request information includes authentication information, and the authentication information includes an AKMA key identifier corresponding to the AKMA anchor key. In this way, the AKMA anchor key can be determined based on the AKMA key identifier, and then the K_{AF} for the CAPIF function to authenticate the identity of the API invoker can be determined based on the AKMA anchor key. This will enable the CAPIF function to authenticate the identity of the API invoker.

An embodiment of the present disclosure provides an API invoker authentication method, which is performed by an API invoker, including:
determining the AKMA anchor key and the AKMA key identifier corresponding to the AKMA anchor key based on an authentication server function key (K_{AUSF}); and
determining a first application function key (K_{AF}) based on the AKMA anchor key.

In some embodiments, determining the first K_{AF} based on the AKMA anchor key includes one of the following:
determining the first K_{AF} based on the AKMA anchor key and identification information of the CAPIF function, where the identification information of the CAPIF function includes a fully qualified domain name (FQDN) and/or a security protocol identifier, and the security protocol identifier is determined by negotiation between the API invoker and the CAPIF function.

In an embodiment, the identification information of the CAPIF function may be AF_ID.

An embodiment of the present disclosure provides an API invoker authentication method, which is performed by an API invoker, including: obtaining an authentication server function key (K_{AUSF}). For example, the API invoker may obtain the K_{AUSF} from the API provider domain; or, the API invoker may determine the K_{AUSF}.

In an embodiment, the security protocol identifier may be a Ua* protocol security protocol identifier.

An embodiment of the present disclosure provides an API invoker authentication method, which is performed by an API invoker, including:
determining the first K_{AF} based on the AKMA anchor key and identification information of the CAPIF function, where the identification information of the CAPIF function includes a fully qualified domain name (FQDN) and/or a security protocol identifier, and the security protocol identifier is determined by negotiation between the API invoker and the CAPIF function.

Of course, in other embodiments, the identification information of the CAPIF function may be any kind of identification information that uniquely characterizes the CAPIF function. For example, the identification information of the CAPIF function may be number information of the CAPIF function; or, for example, a physical address of the identification information of the CAPIF function is determined.

For example, the API invoker generates the first K_{AF} based on the AKMA anchor key and the FQDN.

For example, the API invoker generates the first K_{AF} based on the AKMA anchor key, the FQDN and the security protocol identifier.

In the embodiment of the present disclosure, the API invoker may determine an AKMA anchor key and an AKMA key identifier corresponding to the AKMA anchor key based on the K_{AUSF}, where the AKMA anchor key may be used by the API invoker to generate a first K_{AF} for authentication of the API invoker; and the AKMA key identifier may be used to be sent to the CAPIF function for the CAPIF function to obtain a second K_{AF} for authentication of the API invoker based on the AKMA key identifier.

An embodiment of the present disclosure provides an API invoker authentication method, which is performed by an API invoker, including: determining whether the identity authentication of the API invoker is successful based on the first K_{AF} and a second K_{AF} of the CAPIF function.

Here, whether the identity authentication of the API invoker is successful can be determined based on whether the first K_{AF} and the second K_{AF} match. If the first K_{AF} does not match the second K_{AF}, it is determined that the identity authentication of the API invoker is unsuccessful. Or, if the first K_{AF} matches the second K_{AF}, it is determined that the identity authentication of the API invoker is successful.

For example, the API invoker encrypts first information using the first K_{AF} to obtain encrypted second information. The API invoker sends the second information to the CAPIF function. The CAPIF function can decrypt the second information based on the second K_{AF} to obtain the first information. In this way, the first K_{AF} matches the second K_{AF}.

In the embodiment of the present disclosure, the first K_{AF} and the second K_{AF} are generated based on the same AKMA anchor key. If the first K_{AF} matches the second K_{AF}, it can be determined that the identity authentication of the API invoker is successful, and the API invoker is not a forged identity.

In some embodiments, the authentication information includes: a first certificate, where the first certificate is used for the CAPIF function to authenticate the identity of the API invoker.

As shown in FIG. 5, an embodiment of the present disclosure provides an API invoker authentication method, which is performed by an API invoker, including the following step.

At step S51, sending first request information to a CAPIF function, where the first request information includes the authentication information of the API invoker, and the authentication information includes a first certificate, where the first certificate is used for the CAPIF function to authenticate the identity of the API invoker.

Here, the first certificate may be a certificate generated by an authority for the API invoker or a certificate generated by the CAPIF Core Function for the API invoker.

Here, the first certificate is used for the CAPIF function to authenticate the identity of the API invoker based on the first certificate and a root certificate stored in the CAPIF. Here, the root certificate corresponds to the first certificate stored in the CAPIF or obtained from other functions.

In this way, in the embodiment of the present disclosure, the API invoker can send its own first certificate, so that the CAPIF can realize identity authentication of the API invoker based on the certificate.

It should be noted that those skilled in the art can understand that the methods provided by the embodiments of the present disclosure can be executed alone or together with some methods in the embodiments of the present disclosure or some methods in related technologies.

As shown in FIG. 6, an embodiment of the present disclosure provides an API invoker authentication method, which is performed by an API invoker, including the following step.

At step S61, receiving first response information sent by the CAPIF function, where the first response information includes at least one of: API invoker configuration information, an API invoker's certificate, or an onboard signing key of the API invoker.

Here, the API invoker configuration information includes: AEF authentication information and authorization information.

Here, the API invoker's certificate includes at least one of: identification information of the API invoker and a public key of the API invoker.

Here, the identification information of the API invoker includes, but is not limited to, one of the following: identification information of the API invoker assigned by the CAPIF, a a subscription permanent identifier (SUPI), a generic public subscription identifier (GPSI), an internet protocol multimedia subsystem (IMS) private identity (IMPI), a subscription concealed identifier (SUCI) and an application layer identification (ID) of UE.

In some embodiments of the present disclosure, the API invoker may be the API invoker in step S21 and the CAPIF function may be the CAPIF function in step S21.

Here, the API invoker's certificate includes but is not limited to at least one of the following: identification information of the API invoker, or a public key of the API invoker and the identification information of the API invoker.

Here, the first response information is sent by the CAPIF after successfully authenticating the identity of the API invoker.

In an embodiment, the first response information may be an Onboard API invoker response message.

In the embodiment of the present disclosure, after the identity of the API invoker is successfully authenticated by the CAPIF function, the CAPIF function can reassign the API invoker's certificate, the API invoker configuration information and the onboard signing key of the API invoker to the API invoker. In this way, it is beneficial for secure interaction between the API invoker and functions such as CAPIF subsequently.

In some embodiments, the first request information further includes: a token of the API invoker, where the first response information is sent by the CAPIF after successful verification based on the token.

In the embodiment of the present disclosure, after the identity authentication of the API invoker is successful, the CAPIF function can further verify based on the token of the API invoker, and generate the API invoker configuration information (profile) only after the token verification is successful. In this way, the identity of API can be further authenticated to improve the security of subsequent onboarding interaction.

It should be noted that those skilled in the art can understand that the methods provided by the embodiments of the present disclosure can be executed alone or together with some methods in the embodiments of the present disclosure or some methods in related technologies.

The following API invoker authentication method, which is performed by an AAnF, is similar to the above description of the API invoker authentication method performed by the API invoker, and for technical details not disclosed in the embodiment of the API invoker authentication method performed by the AAnF, please refer to the description of the example of the API invoker authentication method performed by the API invoker, which is not described and illustrated in detail herein.

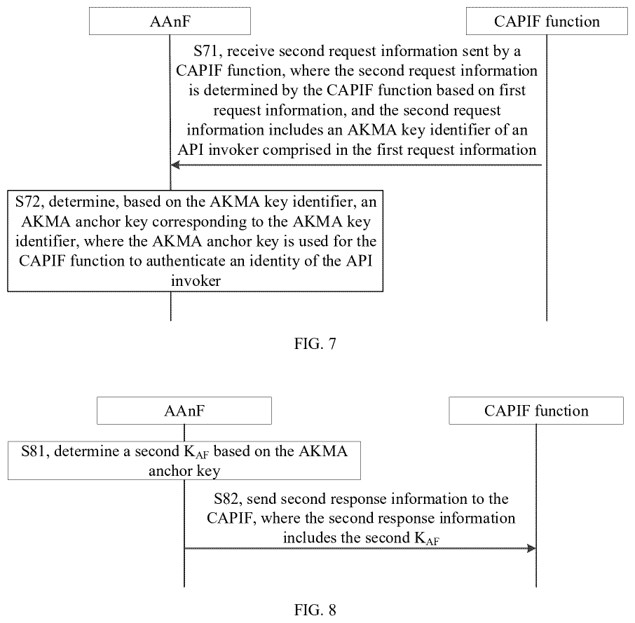

As shown in FIG. 7, an embodiment of the present disclosure provides an API invoker authentication method, which is performed by an AAnF, including the following steps.

At step S71, receiving second request information sent by a CAPIF function, where the second request information is determined by the CAPIF function based on first request information, and the second request information includes an AKMA key identifier of an API invoker included in the first request information.

At step S72, determining, based on the AKMA key identifier, an AKMA anchor key corresponding to the AKMA key identifier, where the AKMA anchor key is used for the CAPIF function to authenticate an identity of the API invoker.

Here, the second request information may be application key request information (Naanf_AKMA_ApplicationKey).

In some embodiments of the present disclosure, the API invoker may be the API invoker in the embodiments described above, the CAPIF function may be the CAPIF function in the embodiments described above, and the AAnF may be the AAnF in the embodiments described above.

For example, the API invoker may be, but is not limited to, a UE.

For example, the CAPIF function may be, but is not limited to: a CAPIF core function (CCF), an API exposing function (AEF) and an authorization function (AF).

Here, the second request information is sent by the CAPIF function after receiving the first request information. Here, the first request information may be the first request information in the above embodiment.

Here, the second request information is at least used to request a K_{AF}.

In this way, in the embodiment of the present disclosure, the AAnF can receive the second request information, where the second request information includes the AKMA key identifier, and the AAnF determines the AKMA anchor key based on the AKMA key identifier. This is beneficial for the AAnF to determine the second K_{AF} based on the AKMA anchor key for CAPIF function to authenticate the identity of API invoker.

An embodiment of the present disclosure provides an API invoker authentication method, which is performed by an AAnF, including: sending an AKMA anchor key to the CAPIF function. For example, the API invoker sends second response information to the CAPIF function, where the second response information includes the AKMA anchor key. In this way, the AKMA anchor key can also be used by CAPIF to generate the second K_{AF}.

It should be noted that those skilled in the art can understand that the methods provided by the embodiments of the present disclosure can be executed alone or together with some methods in the embodiments of the present disclosure or some methods in related technologies.

As shown in FIG. 8, an embodiment of the present disclosure provides an API invoker authentication method, which is performed by an AAnF, including the following steps.

At step S81, determining a second K_{AF} based on the AKMA anchor key.

At step S82, sending second response information to the CAPIF, where the second response information includes the second K_{AF}.

In some embodiments, the second response information further includes a valid time corresponding to the second K_{AF}, and/or identification information of the API invoker.

In some embodiments of the present disclosure, the identification information of the API invoker may be the identification information of the API invoker in the above embodiments. For example, the identification information of the API invoker includes one of the following: a SUPI, a GPSI, an IMPI, a SUCI and an application layer ID of UE.

In an embodiment, the second response information includes at least one of the following:
the second K_{AF};
the second K_{AF} and the valid time of the second KAF;
the second K_{AF} and the identification information of the API invoker; or
the second K_{AF}, the valid time of the second KAF and the identification information of the API invoker.

For example, the AAnF sends the second response information to the CAPIF, where the second response information includes the second K_{AF}. In this way, the CAPIF can obtain the second K_{AF}, so that the CAPIF can authenticate the identity of the API invoker based on the second K_{AF}.

For example, the AAnF sends the second response information to the CAPIF, where the second response information includes the second KAF and the valid time of the second K_{AF}. In this way, the CAPIF can obtain the second K_{AF} and the valid time of the second K_{AF}, so that CAPIF can authenticate the identity of the API invoker based on the second K_{AF} within the valid time.

For example, the AAnF sends the second response information to the CAPIF, where the second response information includes the second K_{AF} and the identification information of the API invoker. In this way, the CAPIF can know which API invoker is being authenticated.

In this way, in the embodiment of the present disclosure, the AAnF can provide the CAPIF with at least one of the second K_{AF}, the valid time of the second K_{AF} or the identification information of the API invoker, so as to facilitate the CAPIF to realize the identity authentication of the API invoker.

In some embodiments, the second request information includes: identification information of the CAPIF function.

Step S81 includes: determining the second K_{AF} based on the AKMA anchor key and the identification information of the CAPIF function.

An embodiment of the present disclosure provides an API invoker authentication method, which is performed by an AAnF, including: determining the second K_{AF} based on the AKMA anchor key and the identification information of the CAPIF function.

In some embodiments, the identification information of the CAPIF function includes: a FQDN and/or a security protocol identifier;
where the determining the second K_{AF} based on the AKMA anchor key and the identification information of the CAPIF function includes one of:
determining the second K_{AF} based on the AKMA anchor key and the FQDN; and
determining the second K_{AF} based on the AKMA anchor key, the FQDN and the security protocol identifier.

In some embodiments of the present disclosure, the FQDN and the security protocol identifier may be the FQDN and the security protocol identifier in the above embodiments.

For example, the FQDN may be, but is not limited to, a combination of a host name and a domain name of the CAPIF function, or a name of a host name with the CAPIF function and a domain name.

For example, the security protocol identifier is determined by negotiation between the API invoker and the CAPIF function. The security protocol identifier may be a Ua* protocol security protocol identifier.

In the embodiment of the present disclosure, the AAnF can generate the second K_{AF} in the same way as the API invoker, which can ensure the consistency of the generated K_{AF}.

In some embodiments, the method includes: determining, based on the identification information of the CAPIF function, whether the AAnF is capable of providing a service to the CAPIF function.

In step S72, the determining, based on the AKMA key identifier, an AKMA anchor key corresponding to the AKMA key identifier including: in response to determining that the AAnF is capable of providing the service to the CAPIF function, determining, based on the AKMA key identifier, the AKMA anchor key corresponding to the AKMA key identifier.

It should be noted that those skilled in the art can understand that the methods provided by the embodiments of the present disclosure can be executed alone or together with some methods in the embodiments of the present disclosure or some methods in related technologies.

As shown in FIG. 9, an embodiment of the present disclosure provides an API invoker authentication method, which is performed by an AAnF, including the following steps.

At step S91, determining, based on the identification information of the CAPIF function, whether the AAnF is capable of providing a service to the CAPIF function.

At step S92, in response to determining that the AAnF is capable of providing the service to the CAPIF function, determining, based on the AKMA key identifier, the AKMA anchor key corresponding to the AKMA key identifier.

Here, the AAnF is capable of providing the service to the CAPIF function may be: the AAnF is capable of providing a K_{AF} service for the CAPIF function, etc.

Here, the identification information of the CAPIF function in step S91 may be: the FQDN of the CAPIF function. Of course, in other embodiments, the identification information of the CAPIF function in step S91 may be any other identification information that uniquely identifies the CAPIF function.

In this way, in the embodiment of the present disclosure, it can be determined whether the AAnF is capable of providing the service to the CAPIF function based on the identification information of the CAPIF function, and if so, the AKMA anchor key can be determined based on the AKMA key identifier. In this way, it can be possible to reduce the power consumption consumed by determining the AKMA anchor key based on the AKMA key identifier provided by the CAPIF function in the event that the AAnF is not capable of providing the service to the CAPIF function, or the like.

An embodiment of the present disclosure provides an API invoker authentication method, which is performed by an AAnF, including: in response to determining that the AAnF is not capable of providing the service to the CAPIF function, refusing to provide the second K_{AF} to the CAPIF. Here, the operation of determining the second K_{AF} and/or the operation of sending the second response information to CAPIF can be directly refused.

An embodiment of the present disclosure provides an API invoker authentication method, which is performed by an AAnF, including: if an AKMA anchor key corresponding to the AKMA key identifier is present in the AAnF, determining the AKMA anchor key corresponding to the AKMA key identifier based on the AKMA key identifier.

Here, the AAnF stores mapping information, which includes at least one AKMA key identifier and an AKMA anchor key corresponding to the AKMA key identifier. In this way, the AAnF queries the AKMA anchor key corresponding to the AKMA key identifier based on the AKMA key identifier and the mapping information.

An embodiment of the present disclosure provides an API invoker authentication method, which is performed by an AAnF, including: sending the second response information with error indication information to the CAPIF function based on the AKMA anchor key corresponding to the AKMA key identifier is not present in the AAnF.

Here, the error indication information is used to indicate that the AKMA anchor key corresponding to the AKMA key identifier is not present in the AAnF.

In the embodiment of the present disclosure, when the AKMA anchor key corresponding to the AKMA key identifier is not present in the AAnF, the CAPIF function can be informed that the second K_{AF} cannot be provided for the CAPIF function by sending error indication information.

For the above implementation, please refer to the description on the API invoker side for details, and will not be described again here.

It should be noted that those skilled in the art can understand that the methods provided by the embodiments of the present disclosure can be executed alone or together with some methods in the embodiments of the present disclosure or some methods in related technologies.

The following API invoker authentication method, which is performed by a CAPIF function, is similar to the above description of the API invoker authentication method performed by the API invoker and/or the AAnF, and for technical details not disclosed in the embodiment of the API invoker authentication method performed by the CAPIF function, please refer to the description of the example of the API invoker authentication method performed by the API invoker and/or the AAnF, which is not described and illustrated in detail herein.

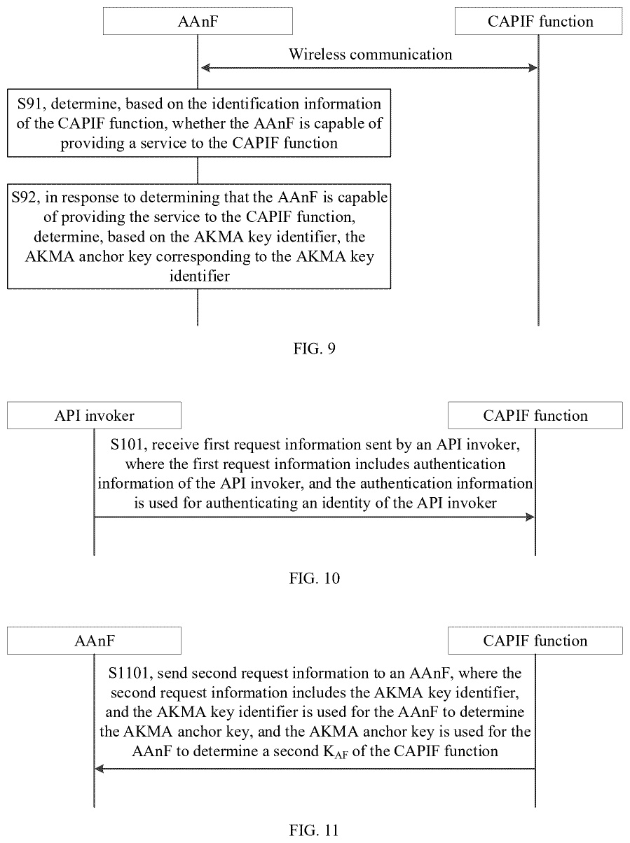

As shown in FIG. 10, an embodiment of the present disclosure provides an API invoker authentication method, which is performed by a CAPIF function, including the following step.

At step S101, receiving first request information sent by an API invoker, where the first request information includes authentication information of the API invoker, and the authentication information is used for authenticating an identity of the API invoker.

In some embodiments of the present disclosure, the API invoker may be the API invoker in the embodiments described above, the CAPIF function may be the CAPIF function in the embodiments described above, and the AAnF may be the AAnF in the embodiments described above.

For example, the API invoker may be, but is not limited to, a UE.

For example, the CAPIF function may be, but is not limited to: a CAPIF core function (CCF), an API exposing function (AEF) and an authorization function (AF).

In some embodiments of the present disclosure, the first request information and the enrolment information may be the first request information and the enrolment information in the above embodiments, respectively.

For example, the first request information may include, but is not limited to, at least one of: a token of the API invoker, a key pair of the API invoker, and a public key of the API invoker. Here, the key pair of the API invoker includes a private key and a public key of the API invoker.

For example, the enrolment information may be onboarding enrolment information.

It should be noted that those skilled in the art can understand that the methods provided by the embodiments of the present disclosure can be executed alone or together with some methods in the embodiments of the present disclosure or some methods in related technologies.

In some embodiments, the authentication information includes an AKMA key identifier corresponding to an AKMA anchor key, where the AKMA key identifier is used for determining the AKMA anchor key, and the AKMA anchor key is used for authenticating the identity of the API invoker.

An embodiment of the present disclosure provides an API invoker authentication method, which is performed by a CAPIF function, including:
receiving first request information sent by the API invoker, where the first request information includes authentication information of the API invoker, and the authentication information includes an AKMA key identifier corresponding to an AKMA anchor key, where the AKMA key identifier is used for determining the AKMA anchor key, and the AKMA anchor key is used for authenticating the identity of the API invoker.

Here, the AKMA key identifier is used for the AAnF to determine the AKMA anchor key. The AKMA anchor key is used for the AAnF to determine a second K_{AF} or the AKMA anchor key is used for the API invoker to determine a first K_{AF}.

In an embodiment, the AKMA anchor key may also be used for the CAPIF function to determine the second K_{AF}.

For example, the CAPIF receives the AKMA anchor key sent by the AAnF and determines the second K_{AF} based on the AKMA anchor key and identification information of the CAPIF function.

As shown in FIG. 11, an embodiment of the present disclosure provides an API invoker authentication method, which is performed by a CAPIF function, including the following step.

At step S1101, sending second request information to an AAnF, where the second request information includes the AKMA key identifier, and the AKMA key identifier is used for the AAnF to determine the AKMA anchor key, and the AKMA anchor key is used for the AAnF to determine a second K_{AF} of the CAPIF function.

Here, the second request information may be application key request information (Naanf_AKMA_ApplicationKey).

An embodiment of the present disclosure provides an API invoker authentication method, which is performed by a CAPIF function, including:
the second K_{AF};
identification information of the API invoker and the second K_{AF};
the second K_{AF} and a valid time corresponding to the second K_{AF}; or
identification information of the API invoker, the second K_{AF} and a valid time corresponding to the second K_{AF}.

In some embodiments of the present disclosure, the identification information of the API invoker may be the identification information of the API invoker in the above embodiments. For example, the identification information of the API invoker includes one of the following: a SUPI, a GPSI, and an IMPI.

An embodiment of the present disclosure provides an API invoker authentication method, which is performed by a CAPIF function, including: authenticating the identity of the API invoker based on the second K_{AF} and the first K_{AF} of the API invoker.

For example, the CAPIF function receives second information sent by the API invoker, which is the information after the API invoker encrypted the first information based on the first K_{AF}. The CAPIF function uses the second K_{AF} to decrypt the second information. If the first information is obtained, it is determined that the identity authentication of the API invoker is successful.

For example, the CAPIF function receives the first K_{AF} sent by the API invoker, if it is determined that the first K_{AF} matches the second K_{AF} provided by the CAPIF function, it is determined that the identity authentication of the API invoker is successful.

In this way, in the embodiment of the present disclosure, the CAPIF may realize the identity authentication of the API invoker based on the application function key.

An embodiment of the present disclosure provides an API invoker authentication method, which is performed by a CAPIF function, including: determining the AAnF corresponding to the CAPIF function based on the AKMA key identifier.

Here, the AKMA key identifier can be used for the CAPIF function to select the corresponding AAnF.

In some embodiments, the second request information includes: identification information of the CAPIF function, where the identification information of the CAPIF function includes a fully qualified domain name (FQDN) and/or a security protocol identifier, and the security protocol identifier is determined by negotiation between the API invoker and the CAPIF function; and the AKMA anchor key and the identification information of the CAPIF function are used for the AAnF to determine the second K_{AF}.

Here, the AKMA anchor key and the identification information of the CAPIF function can also be used by the API invoker to determine the first K_{AF}.

It should be noted that those skilled in the art can understand that the methods provided by the embodiments of the present disclosure can be executed alone or together with some methods in the embodiments of the present disclosure or some methods in related technologies.

In some embodiments, the authentication information includes: a first certificate, where the first certificate is used for the CAPIF function to authenticate the identity of the API invoker.

An embodiment of the present disclosure provides an API invoker authentication method, which is performed by the CAPIF function, including: receiving first request information sent by the API invoker, where the first request information includes authentication information of the API invoker, and the authentication information includes: a first certificate, where the first certificate is used for the CAPIF function to authenticate the identity of the API invoker.

An embodiment of the present disclosure provides an API invoker authentication method, which is performed by the CAPIF function, including: determining whether the identity authentication of the API invoker is successful based on the first certificate and a root certificate corresponding to the first certificate stored by the CAPIF function.

Here, if the first certificate matches the root certificate stored by the CAPIF function, it is determined that the identity authentication of the API invoker is successful.

Here, the CAPIF function stores at least one root certificate, each corresponding to an API invoker.

In this way, in the embodiment of the present disclosure, the CAPIF may realize the identity authentication of the API invoker based on the certificate.

It should be noted that those skilled in the art can understand that the methods provided by the embodiments of the present disclosure can be executed alone or together with some methods in the embodiments of the present disclosure or some methods in related technologies.

An embodiment of the present disclosure provides an API invoker authentication method, which is performed by a CAPIF function, including:
determining, based on successful identity authentication of the API invoker, an onboard signing key of the API invoker;
determining, based on successful identity authentication of the API invoker, API invoker configuration information of the API invoker, where the API invoker configuration information includes: API exposing function (AEF) authentication and authorization information; or
generating, based on successful identity authentication of the API invoker, an API invoker's certificate, where the API invoker's certificate includes a public key of the API invoker and identification information of the API invoker.

In some embodiments, the first request information further includes: a token of the API invoker;
where the determining API invoker configuration information of the API invoker includes: determining, based on the successful identity authentication of the API invoker, the API invoker configuration information according to the token.

An embodiment of the present disclosure provides an API invoker authentication method, which is performed by the CAPIF function, including: determining, based on the successful identity authentication of the API invoker, the API invoker configuration information according to the token of the API invoker.

An embodiment of the present disclosure provides an API invoker authentication method, which is performed by the CAPIF function, including: sending first response information to the API invoker, where the first response information includes at least one of: onboard signing information of the API invoker, the API invoker configuration information and the API invoker's certificate.

For the above implementation, please refer to the description on the API invoker and/or CAPIF side for details, and will not be described again here.

It should be noted that those skilled in the art can understand that the methods provided by the embodiments of the present disclosure can be executed alone or together with some methods in the embodiments of the present disclosure or some methods in related technologies.

The following API invoker authentication method, which is performed by a communication device, is similar to the above description of the API invoker authentication method performed by the API invoker and/or the AAnF and/or the CAPIF function, and for technical details not disclosed in the embodiment of the API invoker authentication method performed by the communication device, please refer to the description of the example of the API invoker authentication method performed by the API invoker and/or the AAnF and/or the CAPIF function, which is not described and illustrated in detail herein.

An embodiment of the present disclosure provides an API invoker authentication method, which is performed by a network device, where the network device includes an API invoker, an AAnF and/or a CAPIF function; the API invoker method includes the following.

The API invoker determines an AKMA anchor key and an AKMA key identifier corresponding to the AKMA anchor key based on a K_{AUSF}, determines a first K_{AF} based on the AKMA anchor key, and sends first request information to the CAPIF function, where the first request information includes the AMKA key identifier corresponding to the AMKA anchor key.

After receiving the first request information, the CAPIF function sends second request information to the AAnF, where the second request information includes the AMKA key identifier corresponding to the AMKA anchor key.

The AAnF determines, based on the AMKA key identifier, the AKMA anchor key corresponding to the AKMA key identifier, determines a second K_{AF} based on the AKMA anchor key, and sends second response information including the second K_{AF} to the CAPIF function.

The CAPIF function authenticates the identity of the API invoker based on the second K_{AF} and the first K_{AF} provided by the API invoker.

An embodiment of the present disclosure provides an API invoker authentication method, which is performed by a network device, and the network device includes an API invoker and/or a CAPIF function. The API invoker method includes the following.

The API invoker sends first request information to the CAPIF function, where the first request information includes a first certificate.

The CAPIF function authenticates the identity of the API invoker based on the first certificate and a root certificate corresponding to the first certificate stored in the CAPIF function.

For the above implementation, please refer to the description on the API invoker and/or AAnF and/or CAPIF function side for details, and will not be described again here.

It should be noted that those skilled in the art can understand that the methods provided by the embodiments of the present disclosure can be executed alone or together with some methods in the embodiments of the present disclosure or some methods in related technologies.

To further explain any embodiments of the present disclosure, several specific embodiments are provided below.

These specific embodiments can be adapted to the following application scenario. In this application scenario, it is assumed that UE is served as an API invoker, and that both UE and CAPIF function (such as CCF or AEF) support AKMA protocol.

The API invoker and the CAPIF function shall follow the procedure in this subclause to secure and authenticate the onboarding of the API invoker to the CAPIF function. The API invoker and the CAPIF function shall establish a secure session using TLS. Security profiles for TLS implementation and usage shall follow the provisions given in TS 33.310.

With a secure session established, the API invoker sends an Onboard API Invoker Request message to the CAPIF function. The Onboard API Invoker Request message carries an onboard credential (e.g., OAuth 2.0 token), which is obtained from the API provider domain. When the OAuth 2.0 token based mechanism is used as the onboarding credential, the OAuth 2.0 token shall be encoded as JSON web token as specified in IETF RFC 7519, shall include the JSON web signature as specified in IETF RFC 7515, and shall be validated per OAuth 2.0, IETF RFC 7519 and IETF RFC 7515. Of course, other onboard credentials may also be used (e.g. message digest).

### Example 1

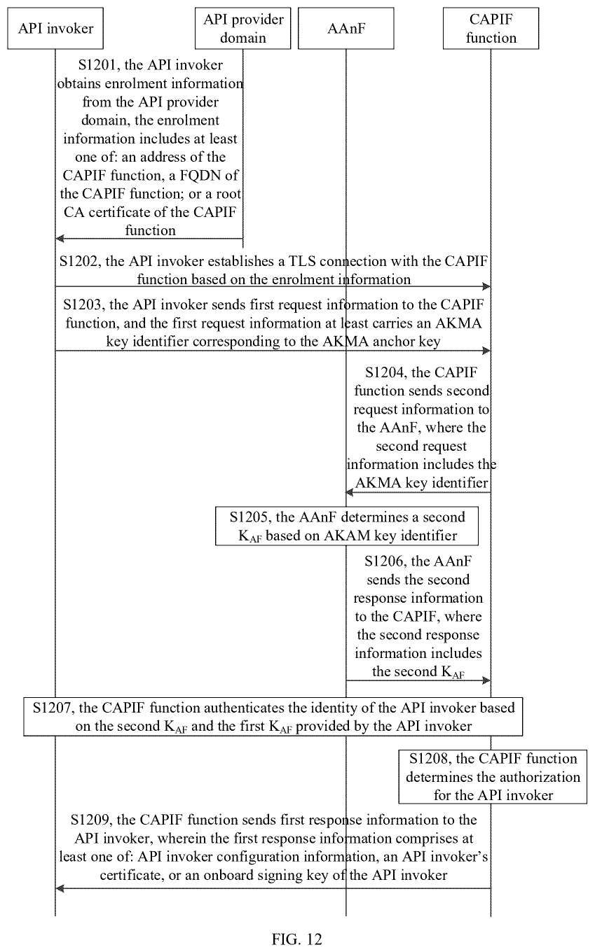

As shown in FIG. 12, an embodiment of the present disclosure provides an API invoker authentication method, which is performed by a network device, and the network device includes: an API invoker, an API provider domain, an AAnF and/or a CAPIF function. The API invoker authentication method includes the following steps.

Here, the CAPIF function may be a CAPIF core function (CCF).

At step S1201, the API invoker obtains enrolment information from the API provider domain, the enrolment information includes at least one of the following: an address of the CAPIF function, a FQDN of the CAPIF function; or a root CA certificate of the CAPIF function.

Here, the enrolment information may be onboarding enrolment information. The online enrolment information is used by the API invoker to authenticate and establish a TLS communication with the CAPIF function during the onboarding procedure.

In an embodiment, as a prerequisite to the onboarding procedure, the API invoker needs to obtain onboarding enrolment information from the API provider domain. The onboarding enrolment information includes the address of CAPIF function, the FQDN of the CAPIF function and the root CA certificate (OAuth 2.0 token) of the CAPIF function.

In an embodiment, the API invoker generates an AKMA anchor key and an AKMA key identifier (A-KID) corresponding to the AKMA anchor key based on K_{AUSF}. The operation in this embodiment can be performed before the API invoker sends first request information to the CAPIF.

In an embodiment, the API invoker generates a first K_{AF} based on the AKMA anchor key. The operation in this embodiment can be performed before or after the API invoker sends the first request to the CAPIF.

At step S1202, the API invoker establishes a TLS connection with the CAPIF function based on the enrolment information.

In an embodiment, the API invoker establishes a secure session for a TLS connection (TLS session) with the CAPIF function based on the enrolment information, and the TLS connection is established after server side certificate authentication.

At step S1203, the API invoker sends first request information to the CAPIF function, and the first request information at least carries an AKMA key identifier corresponding to the AKMA anchor key.

Here, the first request information may be Onboard API invoker request message.

In an embodiment, after successful establishment of the TLS session, the API invoker shall send an Onboard API invoker request message to the CAPIF function, where the Onboard API invoker request message at least includes an AKMA key identifier (A-KID), and the Onboard API invoker request message may further include at least one of the following: an OAuth 2.0 token, a key pair of the API invoker, and a public key of the API invoker. The key pair of the API invoker includes a private key of the API invoker and a public key of the API invoker.

At step S1204, the CAPIF function sends second request information to the AAnF, where the second request information includes the AKMA key identifier.

Here, the second request information may be application key request information (Naanf_AKMA_ApplicationKey).

Here, the second request information may include identification information of the CAPIF function.

In an embodiment, when the CAPIF function determines that there is no context associated with the AKMA key identifier, the CAPIF function selects the AAnF according to the identification information of the CAPIF function, and sends application key request information to the AAnF, where the application key request information includes the AKMA key identifier and is used for requesting the AKMA anchor key.

At step S1205, the AAnF determines a second K_{AF} based on AKAM key identifier.

In an embodiment, the AAnF checks whether the AAnF can provide a service to the CAPIF function based on the identification information of the CAPIF function. If so, perform the operation of obtaining the AKMA anchor key. If not, refuse to provide a second K_{AF} for the CAPIF function.

In an embodiment, the AAnF verifies that the UE is authorized to use the AKMA anchor key based on the presence of the UE-specific AKMA anchor key identified by the AKAM key identifier.

In an embodiment, the AAnF, if it determines that an AKMA anchor key corresponding to the AKMA key identifier is present, determines an AKMA anchor key corresponding to the AKMA key identifier based on the AKMA key identifier; or if it determines that an AKMA anchor key corresponding to the AKMA key identifier is not present, sends an error indication message to the CAPIF.

In an embodiment, if AAnF does not have a K_{AF} corresponding to the AKMA anchor key, a second K_{AF} is generated based on the AKMA anchor key.

At step S1206, the AAnF sends the second response information to the CAPIF, where the second response information includes the second K_{AF}.

In an embodiment, the second response information further includes at least one of the following: a valid time of the second K_{AF} and identification information of the API invoker.

At step S1207, the CAPIF function authenticates the identity of the API invoker based on the second K_{AF} and the first K_{AF} provided by the API invoker.

In an embodiment, the CAPIF function authenticates the identity of the API invoker based on the K_{AF} authentication of the UE as described in 3GPP TS 33.535.

At step S1208, the CAPIF function determines the authorization for the API invoker.

In an embodiment, after the identity authentication of the API invoker passes, the CAPIF function verifies based on the credential information (OAuth 2.0 token). If the authentication is successful based on the OAuth 2.0 token, the CAPIF function determines API invoker configuration information of the API invoker. Here, the CAPIF function can generate API invoker configuration information as specified in the protocol TS 23.222. The API invoker configuration information includes AEF authentication and authorization information, and an API invoker's certificate includes at least one of the following: identification information of the API invoker, or a public key of the API invoker. The identification information of the API invoker includes at least one of the following: identification information of the API invoker assigned by the CAPIF function, a SUPI, a GPSI, an IMPI, a SUCI and an application layer ID of UE. In this way, the API invoker can use the API invoker's certificate, perform the subsequent authentication procedures with the CAPIF core, and establish a secure connection and authentication with the AEF.

In an embodiment, if the signed API service uses Method 3 (as specified in clause 6.5.2.3) for CAPIF-2e security, the CAPIF function can selectively generate an onboard signing key of the API invoker. Here, during the lifetime of the onboarding procedure, a value of the onboard signing key of the API invoker can remain unchanged, and the corresponding relationship between the online signing key of the API invoker and the identification information of the API invoker should be established.

At step S1209, the CAPIF function sends the first response information to the API invoker, where the first response information includes at least one of: API invoker configuration information, an API invoker's certificate, or an onboard signing key of the API invoker.

Here, the first response information may be an Onboard API invoker response message.

### Example 2

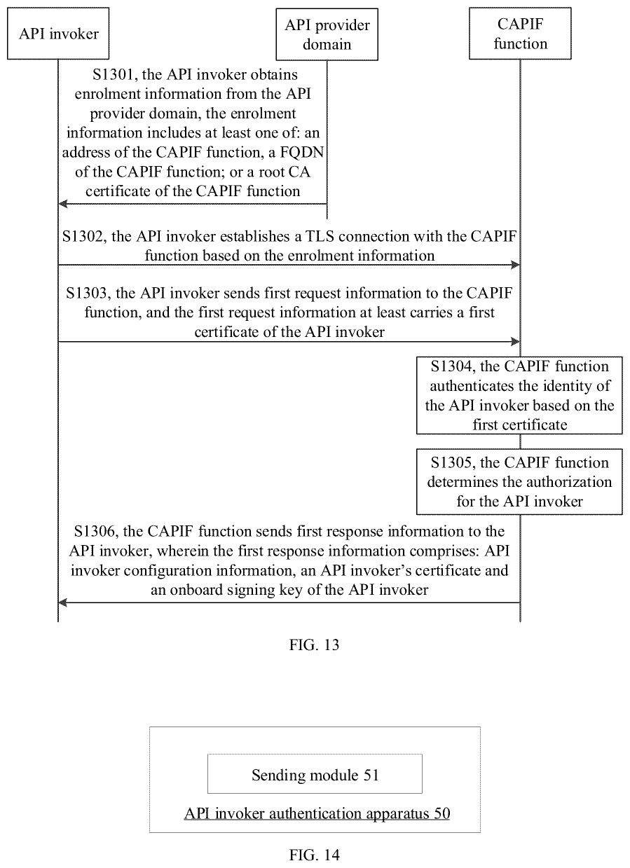

As shown in FIG. 13, an embodiment of the present disclosure provides an API invoker authentication method, which is performed by a network device, and the network device includes: an API invoker, an API provider domain and/or a CAPIF function. The API invoker authentication method includes the following steps.

Here, the CAPIF function may be a CAPIF core function (CCF).

At step S1301, the API invoker obtains enrolment information from the API provider domain, the enrolment information includes at least one of the following: an address of the CAPIF function, a FQDN of the CAPIF function; or a root CA certificate of the CAPIF function.

Here, the enrolment information may be onboarding enrolment information. The online enrolment information is used by the API invoker to authenticate and establish a TLS communication with the CAPIF function during the onboarding procedure.

In an embodiment, as a prerequisite to the onboarding procedure, the API invoker needs to obtain onboarding enrolment information from the API provider domain. The onboarding enrolment information includes the address of CAPIF function, the FQDN of the CAPIF function and the root CA certificate (OAuth 2.0 token) of the CAPIF function.

At step S1302, the API invoker establishes a TLS connection with the CAPIF function based on the enrolment information.

In an embodiment, the API invoker establishes a secure session for a TLS connection (TLS session) with the CAPIF function based on the enrolment information, and the TLS connection is established after server side certificate authentication.

At step S1303, the API invoker sends first request information to the CAPIF function, and the first request information at least carries a first certificate of the API invoker.

Here, the first request information may be Onboard API invoker request message.

In an embodiment, after successful establishment of the TLS session, the API invoker shall send an Onboard API invoker request message to the CAPIF function, where the Onboard API invoker request message at least includes the first certificate of the API invoker, and the Onboard API invoker request message may further include at least one of the following: an OAuth 2.0 token, a key pair of the API invoker, and a public key of the API invoker. The key pair of the API invoker includes a private key of the API invoker and a public key of the API invoker.

At step S1304, the CAPIF function authenticates the identity of the API invoker based on the first certificate.

In an embodiment, the CAPIF function determines whether the identity authentication of the API invoker is successful based on the first certificate and a root certificate corresponding to the first certificate stored by the CAPIF function.

At step S1305, the CAPIF function determines the authorization for the API invoker.

In an embodiment, after the identity authentication of the API invoker passes, the CAPIF function verifies based on the credential information (OAuth 2.0 token). If the authentication is successful based on the OAuth 2.0 token, the CAPIF function determines API invoker configuration information of the API invoker. Here, the CAPIF function can generate API invoker configuration information as specified in the protocol TS 23.222. The API invoker configuration information includes AEF authentication and authorization information, and an API invoker's certificate includes at least one of the following: the public key of the API invoker and the identification information of the API invoker. The identification information of the API invoker includes at least one of the following: identification information of the API invoker assigned by the CAPIF function, a SUPI, a GPSI, an IMPI, a SUCI and an application layer ID of UE. In this way, the API invoker can use the API invoker's certificate, perform the subsequent authentication procedures with the CAPIF core, and establish a secure connection and authentication with the AEF.

In an embodiment, if the signed API service uses Method 3 (as specified in clause 6.5.2.3) for CAPIF-2e security, the CAPIF function can selectively generate an onboard signing key of the API invoker. Here, during the lifetime of the onboarding procedure, a value of the onboard signing key of the API invoker can remain unchanged, and the corresponding relationship between the online signing key of the API invoker and the identification information of the API invoker should be established.

At step S1306, the CAPIF function sends first response information to the API invoker, where the first response information includes: API invoker configuration information, an API invoker's certificate and an onboard signing key of the API invoker.

Here, the first response information may be an Onboard API invoker response message.

It should be noted that those skilled in the art can understand that the methods provided by the embodiments of the present disclosure can be executed alone or together with some methods in the embodiments of the present disclosure or some methods in related technologies.

As shown in FIG. 14, an embodiment of the present disclosure provides an API invoker authentication apparatus 50, including:
a sending module 51, configured to send first request information to a CAPIF function, where the first request information includes authentication information of the API invoker, and the authentication information is used for the CAPIF function to authenticate an identity of the API invoker.

The API invoker authentication apparatus 50 provided by the embodiment of the present disclosure can be applied to an API invoker.

An embodiment of the present disclosure provides an API invoker authentication apparatus 50, including: a receiving module, configured to obtain enrolment information from an API provider domain or preconfigured information of the API invoker, where the enrolment information includes at least one of:
an address of the CAPIF function;
a FQDN of the CAPIF function; or
a root CA certificate of CAPIF function.

An embodiment of the present disclosure provides an API invoker authentication apparatus 50, including: a processing module, configured to establish, based on the enrolment information, a TLS connection with the CAPIF function; and
the sending module 51 is configured to send, based on the TLS connection, the first request information to the CAPIF function.

In some embodiments, the authentication information includes an AKMA key identifier corresponding to an AKMA anchor key, where the AKMA key identifier is used for determining the AKMA anchor key, and the AKMA anchor key is used for the CAPIF function to authenticate the identity of the API invoker.

An embodiment of the present disclosure provides an API invoker authentication apparatus 50, including:
the processing module, configured to determine, based on an authentication server function key (K_{AUSF}), the AKMA anchor key and the AKMA key identifier corresponding to the AKMA anchor key; and
the processing module is further configured to determine, based on the AKMA anchor key, a first K_{AF}.

An embodiment of the present disclosure provides an API invoker authentication apparatus 50, including: the processing module, configured to determine the first K_{AF} based on the AKMA anchor key and identification information of the CAPIF function, where the identification information of the CAPIF function includes a fully qualified domain name (FQDN) and/or a security protocol identifier, and the security protocol identifier is determined by negotiation between the API invoker and the CAPIF function.

An embodiment of the present disclosure provides an API invoker authentication apparatus 50, including: the processing module, configured to determine, based on the first K_{AF} and a second K_{AF} of the CAPIF function, whether the identity authentication of the API invoker is successful.

In some embodiments, the authentication information includes: a first certificate, where the first certificate is used for the CAPIF function to authenticate the identity of the API invoker.

An embodiment of the present disclosure provides an API invoker authentication apparatus 50, including: the receiving module configured to receive first response information sent by the CAPIF function, and the first response information includes:
API invoker configuration information, where the API invoker configuration information includes: API exposing function (AEF) authentication and authorization information;
an API invoker's certificate, where the API invoker's certificate includes: identification information of the API invoker and a public key of the API invoker; and
an onboard signing key of the API invoker.

In some embodiments, the identification information of the API invoker includes one of the following: identification information of the API invoker assigned by the CAPIF function, a SUPI, a GPSI, an IMPI, a SUCI and an application layer ID of UE.

In some embodiments, the first request information further includes: a token of the API invoker, where the first response information is sent by the CAPIF after successful verification based on the token.

In some embodiments, the API invoker includes: a UE.

In some embodiments, the CAPIF function includes one of the following: a CCF, an AEF, and an AF.

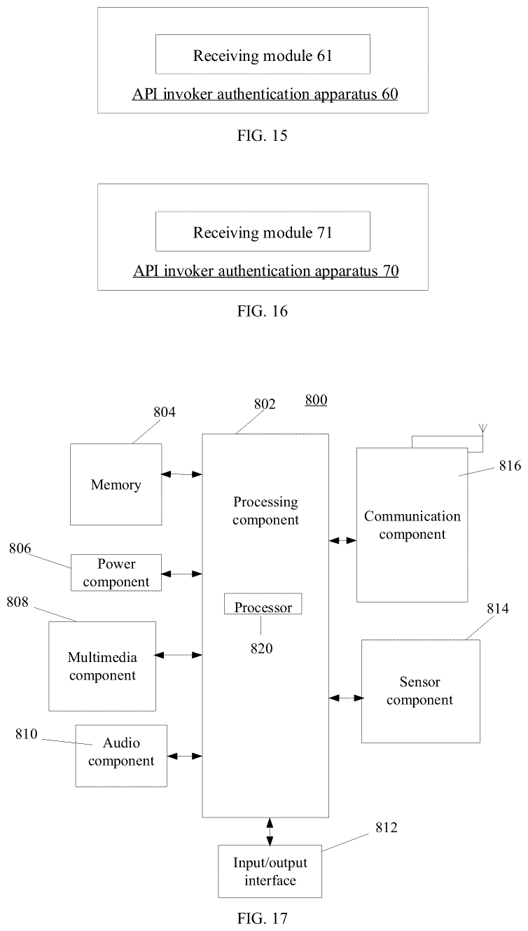

As shown in FIG. 15, an embodiment of the present disclosure provides an API invoker authentication apparatus 60, including:
a receiving module 61, configured to receive second request information sent by a common application program interface framework (CAPIF) function, where the second request information is determined by the CAPIF function based on first request information, and the second request information includes an AKMA key identifier of an API invoker included in the first request information; and
a processing module 62, configured to determine, based on the AKMA key identifier, an AKMA anchor key corresponding to the AKMA key identifier, where the AKMA anchor key is used for the CAPIF function to authenticate an identity of the API invoker.

The API invoker authentication apparatus provided by the embodiment of the present disclosure can be applied to an AAnF.

An embodiment of the present disclosure provides an API invoker authentication apparatus 60, including:
the processing module 62, configured to determine a second K_{AF} based on the AKMA anchor key;
a sending module, configured to send second response information to the CAPIF, where the second response information includes the second K_{AF}.

In some embodiments, the second response information further includes a valid time corresponding to the second K_{AF}, and/or identification information of the API invoker.

In some embodiments, the identification information of the API invoker includes one of the following: a SUPI, a GPSI, an IMPI, a SUCI and an application layer ID of UE.

In some embodiments, the second request information includes: identification information of the CAPIF function, and the identification information of the CAPIF function includes: a fully qualified domain name (FQDN) and/or a security protocol identifier, and the security protocol identifier is determined by negotiation between the API invoker and the CAPIF function.

An embodiment of the present disclosure provides an API invoker authentication apparatus 60, including: the processing module 62, configured to determine the second K_{AF} based on the AKMA anchor key and the identification information of the CAPIF function.

In some embodiments, the identification information of the CAPIF function includes: a fully qualified domain name (FQDN) and/or a security protocol identifier, and the security protocol identifier is determined by negotiation between the API invoker and the CAPIF function.

The processing module is configured to determine the second K_{AF} based on the AKMA anchor key and the FQDN;
or, the processing module is configured to determine the second KAF based on the AKMA anchor key, the FQDN and the security protocol identifier.

An embodiment of the present disclosure provides an API invoker authentication apparatus 60, which includes: the processing module 62, configured to determine, based on the identification information of the CAPIF function, whether the AAnF is capable of providing a service to the CAPIF function; and
the processing module 62, in response to determining that the AAnF is capable of providing the service to the CAPIF function, is further configured to: determine, based on the AKMA key identifier, the AKMA anchor key corresponding to the AKMA key identifier.

An embodiment of the present disclosure provides an API invoker authentication apparatus 60, including: the processing module 62, configured to refuse to provide the second K_{AF} to the CAPIF in response to determining that the AAnF is not capable of providing the service to the CAPIF function.

An embodiment of the present disclosure provides an API invoker authentication apparatus 60, including: the sending module, configured to send, based on the AKMA anchor key corresponding to the AKMA key identifier is not present in the AAnF, the second response information with error indication information to the CAPIF function.

In some embodiments, the API invoker includes: a UE.

In some embodiments, the CAPIF function includes one of the following: a CCF, an AEF and an AF.

As shown in FIG. 16, an embodiment of the present disclosure provides an API invoker authentication apparatus 70, including:
a receiving module 71, configured to receive first request information sent by an application program interface (API) invoker, where the first request information includes authentication information of the API invoker, and the authentication information is used for authenticating an identity of the API invoker.

The API invoker authentication apparatus 70 provided by the embodiment of the present disclosure can be applied to an CAPIF function.

In some embodiments, the authentication information includes an AKMA key identifier corresponding to an AKMA anchor key, where the AKMA key identifier is used for determining the AKMA anchor key, and the AKMA anchor key is used for authenticating the identity of the API invoker.

An embodiment of the present disclosure provides an API invoker authentication apparatus 70, including: a sending module, configured to send second request information to an authentication and key management for applications (AKMA) anchor function (AAnF), where the second request information includes the AKMA key identifier, and the AKMA key identifier is used for the AAnF to determine the AKMA anchor key, and the AKMA anchor key is used for the AAnF to determine a second application function key (K_{AF}) of the CAPIF function.

An embodiment of the present disclosure provides an API invoker authentication apparatus 70, including: a processing module, configured to authenticate, based on the second K_{AF} and a first K_{AF} of the API invoker, the identity of the API invoker.

An embodiment of the present disclosure provides an API invoker authentication apparatus 70, including: the processing module, configure to determine, based on the AKMA key identifier, the AAnF corresponding to the CAPIF function.

An embodiment of the present disclosure provides an API invoker authentication apparatus 70, including: the receiving module 71, configured to receive second response information sent by the AAnF, where the second response information includes at least one of:
the second K_{AF};
identification information of the API invoker and the second K_{AF};
the second K_{AF} and a valid time corresponding to the second K_{AF}; or
identification information of the API invoker, the second K_{AF} and a valid time corresponding to the second K_{AF}.

In some embodiments, the identification information of the API invoker includes one of the following: a SUPI, a GPSI, an IMPI, a SUCI and an application layer ID of UE.

In some embodiments, the second request information includes: identification information of the CAPIF function, where the identification information of the CAPIF function includes a fully qualified domain name (FQDN) and/or a security protocol identifier, and the security protocol identifier is determined by negotiation between the API invoker and the CAPIF function; and the AKMA anchor key and the identification information of the CAPIF function are used for the AAnF to determine the second K_{AF}.

In some embodiments, the authentication information includes: a first certificate, where the first certificate is used for the CAPIF function to authenticate the identity of the API invoker.

An embodiment of the present disclosure provides an API invoker authentication apparatus 70, including: the processing module, configured to determine, based on the first certificate and a root certificate corresponding to the first certificate stored by the CAPIF function, whether the identity authentication of the API invoker is successful.

An embodiment of the present disclosure provides an API invoker authentication apparatus 70, including: the processing module configured to at least one of:
determine, based on successful identity authentication of the API invoker, an onboard signing key of the API invoker;
determine, based on successful identity authentication of the API invoker, API invoker configuration information of the API invoker, where the API invoker configuration information includes: API exposing function (AEF) authentication and authorization information; or
generate, based on successful identity authentication of the API invoker, an API invoker's certificate, where the API invoker's certificate includes a public key of the API invoker and identification information of the API invoker.

In some embodiments, the first request information further includes: a token of the API invoker.

An embodiment of the present disclosure provides an API invoker authentication apparatus 70, including: the processing module configured to determine API invoker configuration information of the API invoker including: determining, based on the successful identity authentication of the API invoker, the API invoker configuration according to the token.

An embodiment of the present disclosure provides an API invoker authentication apparatus 70, including: the sending module configured to send first response information to the API invoker, where the first response information includes at least one of: onboard signing information of the API invoker, the API invoker configuration information and the API invoker's certificate.

In some embodiments, the API invoker includes: a UE.

In some embodiments, the CAPIF function includes one of the following: a CCF, an AEF, and an AF.

It should be noted that those skilled in the art can understand that the apparatuses provided by the embodiments of the present disclosure can be executed alone or together with some apparatuses in the embodiments of the present disclosure or some apparatuses in related technologies.

Regarding to the apparatus in the above embodiment, a specific way in which each module performs operations has been described in detail in the embodiments relating to the method, and will not be described in detail here.

An embodiment of the present disclosure provides a communication device, including:
a processor; and
a memory, configured to store instructions executable by the processor;
where the processor is configured to implement the method of any embodiment of the present disclosure when executing the executable instructions.

In an embodiment, the communication device may include, but is not limited to, at least one of an API invoker, an AAnF or a CAPIF function. Here, the API invoker may be a UE, and the CAPIF function may be a CCF, an AEF or an AF.

The processor may include various types of storage media that are non-transitory computer storage media capable of continuing to memorize the information stored thereon after the user equipment is powered down.

The processor may be connected to the memory via a bus, etc., for reading an executable program stored on the memory, e.g., at least one of the methods as shown in FIGS. 2 to 13.

An embodiment of the present disclosure further provides a computer storage medium, where the computer storage medium stores a computer executable program, and the executable program, when executed by a processor, implements the method of any embodiment of the present disclosure. For example, at least one of the methods shown in FIGS. 2 to 13.

Regarding to the apparatus or storage medium in the above embodiment, a specific way in which each module performs operations has been described in detail in the embodiments relating to the method, and will not be described in detail here.

FIG. 17 is a block diagram of a user equipment 800 according to an embodiment of the present disclosure. For example, the user equipment 800 may be a mobile phone, a computer, a digital broadcasting user equipment, a messaging device, a game console, a tablet device, a medical device, a fitness device, a personal digital assistant, etc.

Referring to FIG. 17, the user equipment 800 may include one or more of the following components: a processing component 802, a memory 804, a power component 806, a multimedia component 808, an audio component 810, an input/output (I/O) interface 812, a sensor component 814, and a communication component 816.

The processing component 802 generally controls an overall operation of the user equipment 800, such as operations associated with display, telephone call, data communication, camera operation and recording operation. The processing component 802 may include one or more processors 820 to execute instructions to complete all or part of steps of the above-mentioned method. In addition, the processing component 802 may include one or more modules to facilitate interactions between the processing component 802 and other components. For example, the processing component 802 may include a multimedia module to facilitate interactions between the multimedia component 808 and the processing component 802.

The memory 804 is configured to store various types of data to support operations in the user equipment 800. Examples of these data include instructions of any application program or method for being operated on the user equipment 800, contact data, phone book data, messages, pictures, videos, etc. The memory 804 can be implemented by any type of volatile or non-volatile memory device or combinations thereof, such as static random access memory (SRAM), electrically erasable programmable read-only memory (EEPROM), erasable programmable read-only memory (EPROM), programmable read-only memory (PROM), read-only memory (ROM), magnetic memory, flash memory, magnetic disk or optical disk.

The power component 806 provides power to various components of the user equipment 800. The power component 806 may include a power management system, one or more power supplies, and other components associated with generating, managing and distributing power for the user equipment 800.

The multimedia component 808 includes a screen that provides an output interface between the user equipment 800 and a user. In some embodiments, the screen may include a liquid crystal display (LCD) and a touch panel (TP). If the screen includes a touch panel, the screen may be implemented as a touch screen to receive an input signal from a user. The touch panel includes one or more touch sensors to sense touching, sliding and gestures on the touch panel. The touch sensor may not only sense a boundary of a touching or sliding action, but also detect a duration and a pressure related to the touching or sliding operation. In some embodiments, the multimedia component 808 includes a front camera and/or a rear camera. When the user equipment 800 is in an operation mode, such as a shooting mode or a video mode, the front camera and/or the rear camera can receive external multimedia data. Each front camera and rear camera may be a fixed optical lens system or have focal length and optical zoom capability.

The audio component 810 is configured to output and/or input audio signals. For example, the audio component 810 includes a microphone (MIC) configured to receive external audio signals when the user equipment 800 is in the operation mode, such as a calling mode, a recording mode and a voice recognition mode. The received audio signal may be further stored in the memory 804 or transmitted via the communication component 816. In some embodiments, the audio component 810 further includes a speaker for outputting audio signals.

The I/O interface 812 provides an interface between the processing component 802 and peripheral interface modules, where the peripheral interface modules may be keyboards, click-wheels, buttons, etc. These buttons may include, but are not limited to: home button, volume button, start button and lock button.

The sensor component 814 includes one or more sensors for providing various aspects of state evaluation for the user equipment 800. For example, the sensor component 814 can detect an on/off state of the user equipment 800, a relative positioning of components, for example, the components are the display and the keypad of the user equipment 800, and the sensor component 814 can also detect a position change of the user equipment 800 or a component of the user equipment 800, presence or absence of user contact with the user equipment 800 orientation or acceleration/deceleration of the user equipment 800 and a temperature change of the user equipment 800. The sensor component 814 may include a proximity sensor configured to detect presence of a nearby object without any physical contact. The sensor component 814 may also include an optical sensor, such as a Complementary Metal Oxide Semiconductor (CMOS) or Charge-Coupled Device (CCD) image sensor, for use in imaging applications. In some embodiments, the sensor component 814 may further include an acceleration sensor, a gyroscope sensor, a magnetic sensor, a pressure sensor or a temperature sensor.

The communication component 816 is configured to facilitate wired or wireless communication between the user equipment 800 and other devices. The user equipment 800 can access a wireless network based on communication standards, such as WiFi, 4G or 5G, or combinations thereof. In an embodiment of the present disclosure, the communication component 816 receives a broadcast signal or broadcast related information from an external broadcast management system via a broadcast channel. In an embodiment of the present disclosure, the communication component 816 further includes a near field communication (NFC) module to facilitate short-range communication. For example, the NFC module can be implemented based on radio frequency identification (RFID) technology, infrared data association (IrDA) technology, ultra-wideband (UWB) technology, Bluetooth (BT) technology and other technologies.

In an embodiment of the present disclosure, the user equipment 800 may be implemented by one or more application-specific integrated circuits (ASIC), digital signal processors (DSP), digital signal processing devices (DSPD), programmable logic devices (PLD), field programmable gate arrays (FPGA), controllers, micro-controllers, micro-processors or other electronic components, for executing the above-mentioned method.

In an embodiment of the present disclosure, a non-transitory computer-readable storage medium is further provided, such as the memory 804 including instructions, where the instructions can be executed by a processor 820 of the user equipment 800 to complete the above-mentioned method. For example, the non-transitory computer-readable storage medium may be an ROM, a random access memory (RAM), a CD-ROM, a magnetic tape, a floppy disk, an optical data storage device, etc.

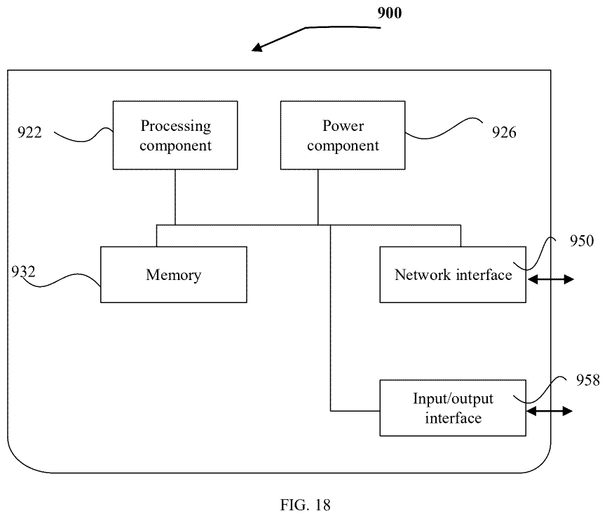

As shown in FIG. 18, an embodiment of the present disclosure shows a structure of a base station. For example, the base station 900 can be provided as a network-side device. Referring to FIG. 18, the base station 900 includes a processing component 922, which further includes one or more processors, and memory resources represented by a memory 932 for storing instructions that can be executed by the processing component 922, such as application programs. An application program stored in the memory 932 may include one or more modules each corresponding to a set of instructions. In addition, the processing component 922 is configured to execute instructions to perform any of the aforementioned methods applied to the base station.

The base station 900 may further include a power component 926 configured to perform power management of the base station 900, a wired or wireless network interface 950 configured to connect the base station 900 to a network, and an input-output (I/O) interface 958. The base station 900 can operate based on an operating system stored in the memory 932, such as Windows Server™, Mac OS X™, Unix™, Linux™, FreeBSD™ or the like.

Other embodiments of the present disclosure will easily occur to those skilled in the art after considering the specification and practicing the present disclosure disclosed herein. The present disclosure is intended to cover any variations, uses or adaptations of the present disclosure, and these variations, uses or adaptations follow general principles of the present disclosure and include common sense or common technical means in the technical field that are not disclosed in the present disclosure. The specification and embodiments are to be regarded as examples only, and true scope and spirit of the present disclosure are indicated by the following claims.

It should be understood that the present disclosure is not limited to precise structures described above and shown in the accompanying drawings, and various modifications and changes can be made without departing from its scope. The scope of the present disclosure is limited only by the appended claims.

1. An method for authenticating an application program interface (API) invoker performed by an API invoker, the method comprising:
sending first request information to a common application program interface framework (CAPIF) function, wherein the first request information comprises authentication information of the API invoker, and the authentication information is used for the CAPIF function to authenticate an identity of the API invoker.

2. The method according to claim 1, further comprising:
obtaining enrolment information from an API provider domain or preconfigured information of the API invoker, wherein the enrolment information comprises at least one of:
an address of the CAPIF function;
a fully qualified domain name (FQDN) of the CAPIF function; or
a root certificate authority (CA) certificate of the CAPIF function;
establishing, based on the enrolment information, a transport layer security (TLS) connection with the CAPIF function; wherein the TLS connection sends the first request information to the CAPIF function.

3-4. (canceled)

5. The method according to claim 41, further comprising:
determining, based on an authentication server function key (K_{AUSF}), an authentication and key management for applications (AKMA) anchor key and an AKMA key identifier corresponding to the AKMA anchor key, wherein the authentication information comprises the AKMA anchor key;
determining, based on the AKMA anchor key, a first application function key (K_{AF}); and
determining, based on the first K_{AF} and a second K_{AF} of the CAPIF function, whether the identity authentication of the API invoker is successful.

6. The method according to claim 5, wherein the determining, based on the AKMA anchor key, a first K_{AF} comprises one of:
determining the first K_{AF} based on the AKMA anchor key and identification information of the CAPIF function, wherein the identification information of the CAPIF function comprises: at least one of a fully qualified domain name (FQDN) or a security protocol identifier, and the security protocol identifier is determined by negotiation between the API invoker and the CAPIF function.

7. (canceled)

8. The method according to claim 1, wherein,
the authentication information comprises: a first certificate, wherein the first certificate is used for the CAPIF function to authenticate the identity of the API invoker.

9. The method according to claim 1, further comprising:
receiving first response information sent by the CAPIF function after successful verification based on a token, wherein the first request information further comprises: the token of the API invoker,
wherein the first response information comprises:
API invoker configuration information, wherein the API invoker configuration information comprises: API exposing function (AEF) authentication and authorization information;
an API invoker's certificate, wherein the API invoker's certificate comprises at least one of: identification information of the API invoker and a public key of the API invoker; and
an onboard signing key of the API invoker;
wherein the identification information of the API invoker comprises one of:
identification information of the API invoker assigned by CAPIF function;
a subscription permanent identifier (SUPI);
a generic public subscription identifier (GPSI);
an internet protocol multimedia subsystem (IMS) private identity (IMPI);
a subscription concealed identifier (SUCI); and
an application layer identification (ID) of UE.

10-11. (canceled)

12. The method according to claim 1, wherein the API invoker comprises: a user equipment (UE).

13. (canceled)

14. A method for authentication of an application program interface (API) invoker performed by an authentication and key management for applications (AKMA) anchor function (AAnF), the method comprising:
receiving second request information sent by a common application program interface framework (CAPIF) function, wherein the second request information is determined by the CAPIF function based on first request information, and the second request information comprises an AKMA key identifier of an API invoker comprised in the first request information; and
determining, based on the AKMA key identifier, an AKMA anchor key corresponding to the AKMA key identifier, wherein the AKMA anchor key is used for the CAPIF function to authenticate an identity of the API invoker.

15. The method according to claim 14, further comprising:
determining a second application function key (K_{AF}) based on the AKMA anchor key and identification information of the CAPIF function comprised in the second request information; and
sending second response information to the CAPIF function, wherein the second response information comprises the second K_{AF}.

16. The method according to claim 15, wherein the second response information further comprises: at least one of a valid time corresponding to the second K_{AF} or identification information of the API invoker;
wherein the identification information of the API invoker comprises one of:
a subscription permanent identifier (SUPI);
a generic public subscription identifier (GPSI);
an internet protocol multimedia subsystem (IMS) private identity (IMPI);
a subscription concealed identifier (SUCI); and
an application layer identification (ID) of UE.

17-18. (canceled)

19. The method according to claim 15, wherein the identification information of the CAPIF function comprises: at least one of a fully qualified domain name (FQDN) or a security protocol identifier, and the security protocol identifier is determined by negotiation between the API invoker and the CAPIF function;
wherein the determining the second K_{AF} based on the AKMA anchor key and the identification information of the CAPIF function comprises one of:
determining the second K_{AF} based on the AKMA anchor key and the FQDN; and
determining the second K_{AF} based on the AKMA anchor key, the FQDN and the security protocol identifier.

20. The method according to claim 14, further comprising:
determining, based on the identification information of the CAPIF function, whether the AAnF is capable of providing a service to the CAPIF function;
in response to determining that the AAnF is capable of providing the service to the CAPIF function, determining, based on the AKMA key identifier, the AKMA anchor key corresponding to the AKMA key identifier;
in response to determining that the AAnF is not capable of providing the service to the CAPIF function, refusing to provide the second K_{AF} to the CAPIF; or
sending, based on the AKMA anchor key corresponding to the AKMA key identifier is not present in the AAnF, the second response information with error indication information to the CAPIF function.

21-23. (canceled)

24. The method according to claim 14, wherein the CAPIF function comprises one of:
a CAPIF core function (CCF);
an API exposing function (AEF); and
an authorization function (AF).

25. A method for authenticating an application program interface (API) invoker performed by a common application program interface framework (CAPIF) function, the method comprising:
receiving first request information sent by an application program interface (API) invoker, wherein the first request information comprises authentication information of the API invoker, and the authentication information is used for authenticating an identity of the API invoker.

26. (canceled)

27. The method according to claim 25, further comprising:
determining, based on an authentication and key management for applications (AKMA) key identifier corresponding to an AKMA anchor key comprised in the authentication information, an AKMA anchor function (AAnF) corresponding to the CAPIF function;
sending second request information to the AAnF, wherein the second request information comprises the AKMA key identifier, and the AKMA key identifier is used for the AAnF to determine the AKMA anchor key, and the AKMA anchor key is used for the AAnF to determine a second application function key (K_{AF}) of the CAPIF function;
receiving second response information sent by the AAnF, wherein the second response information comprises the second K_{AF}; and
authenticating, based on the second K_{AF} and a first K_{AF} of the API invoker, the identity of the API invoker.

28-29. (canceled)

30. The method according to claim 27,
wherein the second response information further comprises at least one of:
identification information of the API invoker; or
a valid time corresponding to the second K_{AF};
wherein the identification information of the API invoker comprises one of:
a subscription permanent identifier (SUPI);
a generic public subscription identifier (GPSI);
an internet protocol multimedia subsystem (IMS) private identity (IMPI);
a subscription concealed identifier (SUCI); and
an application layer identification (ID) of UE.

31. (canceled)

32. The method according to claim 27, wherein the second request information comprises: identification information of the CAPIF function, wherein the identification information of the CAPIF function comprises: at least one of a fully qualified domain name (FQDN) or a security protocol identifier, and the security protocol identifier is determined by negotiation between the API invoker and the CAPIF function; and
the AKMA anchor key and the identification information of the CAPIF function are used for the AAnF to determine the second K_{AF}.

33. (canceled)

34. The method according to claim 25, further comprising:
determining, based on a first certificate comprised in the authentication information and a root certificate corresponding to the first certificate stored by the CAPIF function, whether the identity authentication of the API invoker is successful.

35. The method according to claim 27, wherein the method comprises at least one of:
determining, based on successful identity authentication of the API invoker, an onboard signing key of the API invoker;
determining, based on successful identity authentication of the API invoker, API invoker configuration information of the API invoker according to a token of the API invoker comprised in the first request information, wherein the API invoker configuration information comprises: API exposing function (AEF) authentication and authorization information;
generating, based on successful identity authentication of the API invoker, an API invoker's certificate, wherein the API invoker's certificate comprises a public key of the API invoker and identification information of the API invoker; or
sending first response information to the API invoker, wherein the first response information comprises at least one of: onboard signing information of the API invoker, the API invoker configuration information and the API invoker's certificate.

36-42. (canceled)

43. A communication device, comprising:
a memory, configured to store instructions executable by the processor;
one or more processors communicatively coupled to the memory
wherein the instructions when collectively executed by the one or more processors cause the communication device to act as the API invoker and perform the method according to claim 1.

44. (canceled)
